(19) United States
(12) Patent Application Publication
(10) Pub. No.: US 2015/0175758 A1
(43) Pub. Date: Jun. 25, 2015

(54) BLOCK COPOLYMER AND PROCESS FOR PRODUCTION OF HEAT SHRINKABLE FILM

(71) Applicant: ASAHI KASEI CHEMICALS CORPORATION, Tokyo (JP)

(72) Inventors: Susumu HOSHI, Tokyo (JP); Ryoko FUKUOKA, Tokyo (JP); Yasutaka NAKAMURA, Tokyo (JP)

(73) Assignee: ASAHI KASEI CHEMICALS CORPORATION, Tokyo (JP)

(21) Appl. No.: 14/605,432

(22) Filed: Jan. 26, 2015

Related U.S. Application Data
(62) Division of application No. 12/066,402, filed on Mar. 11, 2008, now abandoned.

(30) Foreign Application Priority Data
Sep. 14, 2005 (JP) 2005-267309
Feb. 13, 2006 (JP) 2006-035278

(51) Int. Cl. C08J 5/18; C08L 53/02; B29C 49/00; C08F 293/00

(52) U.S. Cl. CPC C08J 5/18; C08F 293/00; C08L 53/02; C08L 53/025; B29C 49/0015; C08L 2201/10; C08L 2203/16; C08L 2205/025; C08J 2353/02; C08L 2201/08; C08J 2453/02; B29D 7/01

(57) ABSTRACT

The present invention provides a production process of a heat shrinkable film which is transparent, excellent in the balance of physical properties such as rigidity, elongation and shrink properties in both MD and TD, especially has a uniform film thickness and good stability in extrusion molding film while utilizing an inflation method; a block copolymer or hydrogenated product thereof, or a composition composed thereof excellent in tensile properties, optical properties, hardness, stretch properties, molding processability, shrink properties and solvent resistance and therefore suited for extrusion, injection molding and foams. The production process of a heat shrinkable film has a first inflation step of forming a tube having a thickness of from 0.05 to 0.5 mm by using a block copolymer having a vinyl aromatic hydrocarbon content of from 65 to 95 wt. % and a conjugated diene content of from 5 to 35 wt. %, or a hydrogenated product of the block copolymer; and a second inflation step, successively to the first inflation step, stretching the tube to from 1.5 to 5 times the original length in the TD in a fluid of from 65 to 100° C.

The present application is a divisional of U.S. application Ser. No. 12/066,402, which is a National stage of International Patent Application No. PCT/JP2006/318020 filed Sep. 12, 2006, which claims priority to Japanese Application Nos. 2005-267309 filed Sep. 14, 2005 and 2006-035278 filed Feb. 13, 2006. The disclosures of U.S. application Ser. No. 12/066,402 and International Patent Application No. PCT/JP2006/318020 are incorporated by reference herein in their entireties.

### TECHNICAL FIELD

The present invention relates to a production process, in accordance with an inflation method, of a heat shrinkable film transparent and excellent in the balance of physical properties such as rigidity, elongation and shrink properties in both TD and MD, particularly, having a uniform film thickness and excellent stability in extrusion molding film; and a block copolymer or hydrogenated product thereof, or a composition thereof suited for extruded products (such as extruded sheet, extruded film, stretched sheet, stretched film, and the like), injection moldings, foams, foamed sheets, foamed films, foamed shrinkable films and excellent in tensile properties, optical properties, hardness, stretch properties, molding processability, shrink properties, and the like.

A block copolymer composed of a vinyl aromatic hydrocarbon and a conjugated diene and having a relatively high vinyl aromatic hydrocarbon content has been used for injection moldings and extruded products such as sheets and films by utilizing its properties such as transparency and impact resistance. In particular, a heat shrinkable film using a resin of a block copolymer composed of a vinyl aromatic hydrocarbon and a conjugated diene is free of problems which conventional polyvinyl chloride resins have such as residual monomer, remaining of a plasticizer and emission of hydrogen chloride during incineration so that it has been utilized for food packaging, cap seals, labels and the like. A heat shrinkable film is required to have, as necessary properties, natural shrinkability, low temperature shrinkability, transparency, mechanical strength and suitability for packaging machinery. Various studies have hitherto been made for improving these properties and achieving a good balance among these physical properties.

There is disclosed, for example, a production process of a film using a composition composed of polystyrene and a styrene-butadiene block copolymer in accordance with an inflation method under specific conditions for the purpose of obtaining a polystyrene film which has high tensile strength, impact strength and elongation, is transparent and has high gloss (refer to, for example, Patent Document 1). There is also disclosed a heat shrinkable film comprising a segment of a block copolymer composed of a vinyl aromatic hydrocarbon and a conjugated diene and having a specific Tg for the purpose of obtaining a heat shrinkable film excellent in shrink properties and resistance to environmental destruction, (refer to, for example, Patent Document 2). There is also disclosed a heat shrinkable film comprising a composition of a block copolymer composed of a vinyl aromatic hydrocarbon having a specific structure and a conjugated diene for the purpose of obtaining a heat shrinkable film excellent in shrink properties and resistance to environmental destruction (refer to, for example, Patent Document 3). There is also disclosed a low-temperature shrinkable film obtained by stretching a composition which has a copolymer of a vinyl aromatic hydrocarbon and an aliphatic unsaturated carboxylic acid derivative having a vinyl aromatic hydrocarbon content of from 95 to 20 wt. %, and a Vicat softening point not greater than 90° C. and a copolymer composed of a vinyl aromatic hydrocarbon block and a conjugated diene block for the purpose of obtaining a shrinkable film excellent in low temperature shrinkability, optical properties, crack resistance, dimensional stability and the like (refer to, for example, Patent Document 4). There is also disclosed a polystyrene heat shrinkable film comprising a composition having a block copolymer composed of a styrene hydrocarbon and a conjugated diene hydrocarbon and a random copolymer containing a styrene hydrocarbon and having a specific Tg for the purpose of improving natural shrinkability at room temperature (refer to, for example, Patent Document 5).

There is also disclosed a heat shrinkable rigid film featuring a specific heat shrinking capacity, which comprises a composition having a copolymer composed of a vinyl aromatic hydrocarbon and an aliphatic unsaturated carboxylic acid derivative and having a Vicat softening point not greater than 105° C. and a copolymer of a vinyl aromatic hydrocarbon block and a conjugated diene block for the purpose of obtaining a transparent heat shrinkable film excellent in temporal stability and impact resistance (refer to, for example, Patent Document 6).

There is also disclosed a composition comprising a copolymer composed of a vinyl aromatic hydrocarbon block having a specific structure and a specific molecular weight distribution and a conjugated diene block and a resin of a vinyl aromatic hydrocarbon-(meth)acrylate copolymer for the purpose of obtaining a composition balanced among transparency, rigidity and low-temperature surface impact resistance (refer to, for example, Patent Document 7). There is also disclosed a transparent high-strength resin composition comprising a block copolymer composed of a vinyl aromatic hydrocarbon block and having a specific structure and a conjugated diene block and a copolymer of a vinyl aromatic hydrocarbon and a (meth)acrylate for the purpose of obtaining a resin composition excellent in transparency and impact resistance (refer to, for example, Patent Document 8).

There is also disclosed a multilayer low-temperature shrinkable film comprising at least one layer of a composition having a copolymer composed of a vinyl aromatic hydrocarbon and an aliphatic unsaturated carboxylic acid derivative and having a vinyl aromatic hydrocarbon content of from 95 to 20 wt. % and a Vicat softening point not exceeding 90° C. and a copolymer composed of a vinyl aromatic hydrocarbon block and a conjugated diene block for the purpose of obtaining a shrinkable film excellent in low temperature shrinkability, optical properties, crack resistance and dimensional stability (refer to, for example, Patent Document 9).

There is also disclosed a multilayer polystyrene heat shrinkable film comprising at least three layers, that is, both outer layers each composed of a mixture of a styrene-butadiene-styrene block copolymer having a specific butadiene-unit content and a styrene-butyl acrylate copolymer and an intermediate layer composed of a mixture of a styrene-butadiene-styrene block copolymer having a specific butadiene-unit content and a styrene-butyl acrylate copolymer for the purpose of obtaining a shrinkable film excellent in natural shrinkability, strength, surface properties, rigidity, low temperature shrinkability and the like (refer to, for example, Patent Document 10).

There is also disclosed a heat shrinkable polystyrene laminate film comprising, as an intermediate layer, a mixture having a block copolymer of a vinyl aromatic hydrocarbon and a conjugated diene hydrocarbon and a copolymer of a vinyl aromatic hydrocarbon and an aliphatic unsaturated carboxylate and as both surface layers, a mixed polymer composed mainly of a block copolymer composed of a vinyl aromatic hydrocarbon and a conjugated diene hydrocarbon for the purpose of obtaining a heat shrinkable film excellent in any of natural shrinkability, thermal fusion bonding resistance, transparency and shrinkage finishing properties (refer to, for example, Patent Document 11).

There is also disclosed a multilayer heat shrinkable polystyrene film having a specific heat shrinkage ratio, which comprises an intermediate layer composed mainly of a styrene-(meth)acrylate copolymer having a specific Vicat softening point and inner and outer layers each composed mainly of a styrene-conjugated diene block copolymer having a specific Vicat softening point for the purpose of obtaining a heat shrinkable film having heat shrink properties at low temperatures, shrinkage finishing properties, and a natural shrinkage ratio and not causing blocking between films during heating (refer to, for example, Patent Document 12).

There is also disclosed a (multilayer) heat shrinkable film comprising a layer composed mainly of a resin of a copolymer made of a styrene monomer and a (meth)acrylate monomer and having a specific molecular weight distribution and a specific residual monomer amount, a resin of a block copolymer made of styrene and a conjugated diene, and a high-impact polystyrene resin composition for the purpose of obtaining a resin composition, film or multilayer film excellent in molding processability and storage stability, emitting less odor and excellent in rigidity and impact resistance (refer to, for example, Patent Document 13). There is also disclosed a hydrogenated copolymer having a vinyl aromatic hydrocarbon content, a vinyl aromatic hydrocarbon polymer block content, a weight average molecular weight and a hydrogenation ratio of a double bond of a conjugate diene, each within a specific range for the purpose of obtaining a hydrogenated copolymer having rich flexibility and excellent impact resilience and scratch resistance and easy to handle (refer to, for example, Patent Document 14).

There is also disclosed a hydrogenated copolymer having a vinyl aromatic hydrocarbon content, a vinyl aromatic hydrocarbon polymer block content, a weight average molecular weight, a hydrogenation ratio of a double bond of a conjugated diene and a peak temperature of tan δ each within a specific range for the purpose of obtaining a hydrogenated copolymer excellent in flexibility, tensile strength, abrasion resistance and dint resistance and having good crosslinking properties (refer to, for example, Patent Document 15).

Heat shrinkable films produced, in accordance with an inflation method, by using a block copolymer composed of a vinyl aromatic hydrocarbon and a conjugated diene or hydrogenated product of the block copolymer, or a composition composed of the block copolymer and a copolymer of a vinyl aromatic hydrocarbon and an aliphatic unsaturated carboxylic acid derivative have however a poor balance between transparency and rigidity and do not have a uniform film thickness due to instability in extrusion molding film. The above-described Documents do not disclose a method for improving these properties and they have still been pointed out as problems in the market.

In addition, heat shrinkable films formed using a vinyl aromatic hydrocarbon block copolymer by an inflation method are likely to have unevenness in the thickness owing to stronger stretching in the machine direction (MD). Tenter stretching which facilitates the control of a MD/TD shrinkage ratio and provides a uniform film with good accuracy compared with the inflation process is therefore employed commonly. It is therefore difficult to apply heat shrinkable films produced by the inflation method to PET beverage bottles and the like.

Patent Document 1: Japanese Patent Laid-Open No. Sho 59-49938
Patent Document 2: Japanese Patent Laid-Open No. Sho 60-224520
Patent Document 3: Patent Document Laid-Open No. Sho 60-224522
Patent Document 4: Japanese Patent Laid-Open No. Sho 61-25819
Patent Document 5: Japanese Patent Laid-Open No. Hei 4-52129
Patent Document 6: Japanese Patent Laid-Open No. Hei 5-104630
Patent Document 7: Japanese Patent Laid-Open No. Hei 6-220278
Patent Document 8: Japanese Patent Laid-Open No. Hei 7-216187
Patent Document 9: Japanese Patent Laid-Open No. Sho 61-41544

### Patent Document 10: Japanese Patent Laid-Open No. 2000-185373

### Patent Document 11: Japanese Patent Laid-Open No. 2000-6329

### Patent Document 12: Japanese Patent Laid-Open No. 2002-46231

### Patent Document 13: Japanese Patent Laid-Open No. 2002-201324

### Patent Document 14: WO03/035705

### Patent Document 15: WO04/003027

### DISCLOSURE OF THE INVENTION

### Problems that the Invention is to Solve

An object of the present invention is to provide a process for producing a heat shrinkable film which is transparent and excellent in the balance of physical properties such as rigidity, elongation and shrink properties in both TD and MD, especially has a uniform film thickness and excellent stability in extrusion molding film and is formed by an inflation method; and a block copolymer or hydrogenated product thereof, and a composition thereof excellent in tensile properties, optical properties, hardness, stretch properties, molding processability, shrink properties, and solvent resistance and suited for extrusion, injection molding or foams.

### Means for Solving the Problems

The present inventors have carried out an extensive investigation. As a result, it has been found that the above-described objects can be accomplished by a specific block copolymer or hydrogenated product thereof, or a composition satisfying properties within a specific range or by using the copolymer, hydrogenated product or composition for forming a film by an inflation method, leading to the completion of the present invention.

The present invention relates to the following processes, block copolymers or hydrogenated products thereof, compositions and films.

[1] A process for producing a heat shrinkable film comprising a first inflation step of forming a tube having a thickness of from 0.05 to 0.5 mm by using a material which contains a block copolymer having a vinyl aromatic hydrocarbon content of from 65 to 95 wt. % and a conjugated diene content of from 5 to 35 wt. % or hydrogenated product thereof (I) and has a storage elastic modulus (E′), at 50° C., of from 0.7×10⁹ to 2.5×10° Pa; and a second inflation step, successively to the first inflation step, of stretching the tube to from 1.5 to 5 times the original length in the transverse direction (TD) in a fluid of from 65 to 100° C.

[2] A process for producing a heat shrinkable film according to claim 1, wherein as the material, used is a material which contains a composition composed of the block copolymer or hydrogenated product thereof (I) and at least one of the following (i) to (iv) as Polymer (II):

(i) a block copolymer composed of a vinyl aromatic hydrocarbon and a conjugated diene or hydrogenated product thereof which is different from the block copolymer or hydrogenated product thereof (I),

(ii) a copolymer composed of a vinyl aromatic hydrocarbon and an aliphatic unsaturated carboxylic acid derivative,

(iii) a vinyl aromatic hydrocarbon polymer, and

(iv) a rubber-modified styrene polymer,

at a (I)/(II) weight ratio of from 99/1 to 10/90 and having a vinyl aromatic hydrocarbon content of from 75 to 85 wt. %, and has a storage elastic modulus (E′) at 50° C. within a range of from 0.7×10⁹ to 2.5×10⁹ Pa.

[3] A process for producing a heat shrinkable film as described above in [1] or [2], wherein the tube is formed while setting a draft ratio at from 1 to 15 in the first inflation step.

[4] A process for producing a heat shrinkable film as described above in [2] or [3], wherein the vinyl aromatic hydrocarbon content of the composition is from 76 to 82.5 wt. %.

[5] A process for producing a heat shrinkable film as described above in any one of [1] to [4], wherein from 0.01 to 5 parts by weight of at least one lubricant selected from fatty acid amides, paraffins, hydrocarbon resins and fatty acids is added to 100 parts by weight of the material.

[6] A process for producing a heat shrinkable film as described above in any one of [1] to [4], wherein from 0.05 to 3 parts by weight of at least one stabilizer selected from 2-[1-(2-hydroxy-3,5-di-t-pentylphenyl)ethyl]-4,6-di-t-pentylphenyl acrylate, 2-t-butyl-6-(3-t-butyl-2-hydroxy-5-methylbenzyl)-4-methylphenyl acrylate and 2,4-bis[(octylthio)methyl]-o-cresol is added to 100 parts by weight of the material.

[7] A process for producing a heat shrinkable film as described above in any one of [1] to [4], wherein from 0.05 to 3 parts by weight of at least one ultraviolet absorber or heat stabilizer selected from benzophenone ultraviolet absorbers, benzotriazole ultraviolet absorbers and hindered amine light stabilizers is added to 100 parts by weight of the material.

[8] A process for producing a heat shrinkable film as described above in any one of [1] to [7], wherein a proportion of molecular weights, as measured by gel permeation chromatography (GPC), of 200000 or greater in the material is from 15 to 70 wt. %.

[9] A heat shrinkable film produced by a process as described above in any one of [1] to [8] and having a shrinkage ratio, as measured at 90° C. for 5 seconds, not greater than 20% in the machine direction (MD) and from 20 to 60% in the transverse direction (TD).

[10] A block copolymer having a vinyl aromatic hydrocarbon content of from 65 to 95 wt. % and a conjugated diene content of from 5 to 35 wt. %, or hydrogenated product thereof (III) having a storage rigidity modulus (E′) at 30° C. of 3×10⁸ Pa or greater, having at least one peak temperature of a loss elastic modulus (E″) within a range of 60° C. or greater but not greater than 110° C., which comprises Component (a) having at least one peak molecular weight, as measured by gel permeation chromatography (GPC), within a range of from 30000 to 300000 and Component (b) polymerized by a trifunctional or higher multifunctional coupling agent and having at least one peak molecular weight within a range exceeding 300000 but not greater than 1000000 at a Component (a)/Component (b) weight ratio of from 10/90 to 90/10.

[11] A block copolymer or hydrogenated product thereof (III) as described above in [10], wherein Component (a) has at least one peak molecular weight within a range of from 50000 to 250000.

[12] A block copolymer or hydrogenated product thereof (III) as described above in [10], wherein Component (b) has at least one peak molecular weight within a range exceeding 350000 but not greater than 900000.

[13] A block copolymer or hydrogenated product thereof (III) as described above in any one of [10] to [12], wherein the storage elastic modulus (E′) at 30° C. is 5×10⁸ Pa or greater and the loss elastic modulus (E′) has at least one peak temperature within a range of 65° C. or greater but not greater than 105° C.

[14] A composition comprising a block copolymer or hydrogenated product thereof (III) as described above in any one of [10] to [13] and at least one of the following polymers (α) to (ε) as a polymer (IV):

(α) a block copolymer composed of a vinyl aromatic hydrocarbon and a conjugated diene or hydrogenated product thereof which does not contain the block copolymer or hydrogenated product thereof (III),

(β) a vinyl aromatic hydrocarbon polymer,

(γ) a copolymer composed of a vinyl aromatic hydrocarbon and an aliphatic unsaturated carboxylic acid derivative, and

(ε) a rubber-modified styrene polymer,

at a (III)/(IV) weight ratio of from 1/99 to 99/1.

[15] A composition as described above in [14], wherein a (E′40/E′20) ratio, that is a ratio of a storage elastic modulus at 40° C. (E′40) to a storage elastic modulus at 20° C. (E′20) is from 0.75 to 1, at least one peak temperature of a function tan δ in measurement of a dynamic viscoelasticity is present within a range of from 70 to 125° C., and a weight ratio of the block copolymer or hydrogenated product thereof (III) to the polymer (IV) is from 5/95 to 95/5.

[16] A composition as described above in [14] or [15], which further comprises from 0.01 to 5 parts by weight, based on 100 parts by weight of the block copolymer or hydrogenated product thereof (III) and the polymer (IV), of at least one lubricant selected from fatty acid amides, paraffins, hydrocarbon resins and fatty acids.

[17] A composition as described above in [14] or [15], which further comprises from 0.05 to 3 parts by weight, based on 100 parts by weight of the block copolymer or hydrogenated product thereof (III) and the polymer (IV), of at least one stabilizer selected from 2-[1-(2-hydroxy-3,5-di-t-pentylphenyl)ethyl]-4,6-di-t-pentylphenyl acrylate, 2-t-butyl-6-(3-t-butyl-2-hydroxy-5-methylbenzyl)-4-methylphenyl acrylate and 2,4-bis[(octylthio)methyl]-o-cresol.

[18] A composition as described above in [14] or [15], which further comprises from 0.05 to 3 parts by weight, based on 100 parts by weight of the block copolymer or hydrogenated product thereof (III) and the polymer (IV), of at least one ultraviolet absorber or light stabilizer selected from benzophenone ultraviolet absorbers, benzotriazole ultraviolet absorbers and hindered amine light stabilizers.

[19] A sheet film comprising the block copolymer or hydrogenated product thereof (III) as described above in any one of [10] to [13].

[20] A heat shrinkable film comprising the block copolymer or hydrogenated product thereof (III) as described above in any one of [10] to [13].

[21] A heat shrinkable film obtained by a production process comprising a first inflation step of forming a tube having a thickness of from 0.05 to 0.5 mm at a draft ratio of from 1 to 15 by using the block copolymer or hydrogenated product thereof (III) as described above in any one of [10] to [13]; and a second inflation step, successively to the first inflation step, of stretching the tube to 1.5 to 5 times the original length in the TD in a fluid of from 65 to 100° C.

[22] A sheet film comprising the composition as described above in any one of [14] to [18].

[23] A heat shrinkable film comprising the composition as described in any one of [14] to [18].

[24] A heat shrinkable film obtained by a production process comprising a first inflation step of forming a tube having a thickness of from 0.05 to 0.5 mm at a draft ratio of from 1 to 15 by using a composition as described above in any one of [14] to [18] and a second inflation step, successively to the first inflation step, of stretching the tube to 1.5 to 5 times the original length in the TD in a fluid of from 65 to 100° C.

### Advantage of the Invention

The heat shrinkable film formed by the inflation method according to the present invention is transparent and excellent in the balance of physical properties such as rigidity, elongation and shrink properties in both TD and MD, especially has a uniform film thickness and excellent stability in extrusion molding film; and molded or formed products made of the block copolymer or hydrogenated product thereof, or composition thereof according to the present invention are excellent in tensile properties, optical properties, hardness, stretch properties, molding processability, shrink properties, and the like.

### BEST MODE FOR CARRYING OUT THE INVENTION

The present invention will hereinafter be described more specifically.

The production process of a heat shrinkable film according to the present invention is characterized by that the film is formed by an inflation method while using a material containing a block copolymer having a vinyl aromatic hydrocarbon content of from 65 to 95 wt. % and a conjugated diene content of from 5 to 35 wt. % or a hydrogenated product of the block copolymer (I) (the block copolymer or hydrogenated product thereof may hereinafter be called “Component (I)”) or a material containing a composition composed of Component (I) and at least one of the following polymers (i) to (iv) (which may hereinafter be called “Component (II)”):

(i) a block copolymer composed of a vinyl aromatic hydrocarbon and a conjugated diene or hydrogenated product thereof, different from the block copolymer or hydrogenated product thereof (I),

(ii) a copolymer composed of a vinyl aromatic hydrocarbon and an aliphatic unsaturated carboxylic acid derivative,

(iii) a vinyl aromatic hydrocarbon polymer, and (iv) a rubber-modified styrene polymer.

### [Component I]

The vinyl aromatic hydrocarbon content of Component (I) to be used in the present invention is from 65 to 95 wt. %, preferably from 70 to 93 wt. %, more preferably from 75 to 90 wt. %, while the conjugated diene content is from 5 to 35 wt. %, preferably from 7 to 30 wt. %, more preferably from 10 to 25 wt. %. Vinyl aromatic hydrocarbon contents and conjugate diene contents falling within respective ranges of from 65 to 95 wt. % and from 5 to 35 wt. % make it possible to form a heat shrinkable film excellent in transparency and rigidity. It should be noted that the vinyl aromatic hydrocarbon content of the hydrogenated block copolymer may be considered as that of the block copolymer before hydrogenation.

Component (I) has a peak molecular weight, as measured by gel permeation chromatography (GPC), of from 30000 to 1000000, preferably from 50000 to 850000, still more preferably from 80000 to 700000.

Moreover, Component (I) has preferably at least one peak molecular weight within a molecular weight distribution range from 30000 to 200000 and within a range exceeding 200000 but not greater than 1000000. Use of such Component (I) enables the production of a heat shrinkable film having a uniform thickness and excellent stability in extrusion molding film.

Component (I) of the present invention has at least one segment constructed of a vinyl aromatic hydrocarbon homopolymer and/or a copolymer composed of a vinyl aromatic hydrocarbon and a conjugated diene, and at least one segment constructed of a conjugated diene homopolymer and/or a copolymer composed of a vinyl aromatic hydrocarbon and a conjugated diene. Although no particular limitation is imposed on the polymer structure of Compound (I), there can be used, for example, a linear block copolymer or a radial block copolymer represented by each of the following formulas:

(A-B)ₙ, A-(B-A)ₙ, B-(A-B)ₙ₊₁,

[(A-B)ₖ]ₘ₊₁-X, [(A-B)ₖ-A]ₘ₊₁-X,

[(B-A)ₖ]ₘ₊₁-X, and [(B-A)ₖ-B]ₘ₊₁-X

(wherein, Segment A is a vinyl aromatic hydrocarbon homopolymer and/or a copolymer composed of a vinyl aromatic hydrocarbon and a conjugated diene; Segment B is a conjugated diene homopolymer and/or a copolymer composed of a vinyl aromatic hydrocarbon and a conjugated diene; X represents a residue of a coupling agent such as silicon tetrachloride, tin tetrachloride, 1,3-bis(N,N-glycidylaminomethyl)cyclohexane or epoxidized soybean oil, or a residue of an initiator such as polyfunctional organolithium compound; and n, k and m stand for an integer of 1 or greater, typically an integer from 1 to 5, with the proviso that structures of a plurality of polymer chains bonded to X may be the same or different) or an arbitrary mixture of these polymer structures. Furthermore, in the radial block copolymer represented by the above formula, at least one Segment A and/or B may be bonded to X further.

In the present invention, the vinyl aromatic hydrocarbon in the copolymer composed of a vinyl aromatic hydrocarbon and conjugated diene of Segment A or Segment B may be distributed uniformly or in the tapered form (gradually diminishing form). Alternatively, the copolymer of each Segment may have therein a plurality of portions in which the vinyl aromatic hydrocarbon is distributed uniformly and/or a plurality of portions in which the vinyl aromatic hydrocarbon is distributed in the tapered form. With regard to the relationship between the vinyl aromatic hydrocarbon content in segment A ({vinyl aromatic hydrocarbon in segment A/(vinyl aromatic hydrocarbon+conjugated diene in segment A)}×100) and the vinyl aromatic hydrocarbon content in segment B ({vinyl aromatic hydrocarbon in segment B/(vinyl aromatic hydrocarbon+conjugated diene in segment B)}×100), the vinyl aromatic hydrocarbon content in segment A is greater than the vinyl aromatic hydrocarbon content in segment B. The difference in the vinyl aromatic hydrocarbon content between segment A and segment B is preferably 5 wt. % or greater.

In the present invention, Component (I) is available by polymerizing a vinyl aromatic hydrocarbon and a conjugated diene in a hydrocarbon solvent in the presence of an organolithium compound as an initiator.

Examples of the vinyl aromatic hydrocarbon to be used in the present invention include styrene, o-methylstyrene, p-methylstyrene, p-tert-butylstyrene, 1,3-dimethylstyrene, α-methylstyrene, vinylnaphthalene, vinylanthracene, 1,1-diphenylethylene, N,N-dimethyl-p-aminoethylstyrene, and N,N-diethyl-p-aminoethylstyrene. Of these, styrene is especially typical. They may be used either singly or as a mixture of two or more thereof.

The conjugated diene is a diolefin having a pair of conjugated double bonds. Examples thereof include 1,3-butadiene, 2-methyl-1,3-butadiene (isoprene), 2,3-dimethyl-1,3-butadiene, 1,3-pentadiene, and 1,3-hexadiene. Of these, 1,3-butadiene, isoprene and the like are especially typical. They may be used either singly or as a mixture of two or more thereof.

Component (I) of the present invention may contain at least one polymer block selected from the group consisting of (i) a copolymer block composed of isoprene and 1,3-butadiene, (ii) a copolymer block composed of isoprene and a vinyl aromatic hydrocarbon, and (iii) a copolymer block composed of isoprene, 1,3-butadiene and a vinyl aromatic hydrocarbon. A butadiene/isoprene weight ratio is from 3/97 to 90110, preferably from 5/95 to 85/15, more preferably from 10/90 to 80/20. A hydrogenated block copolymer composed of a block copolymer containing butadiene and isoprene at a weight ratio of from 3/97 to 90/10 does not form a lot of gels in thermoforming, processing and the like when it has a hydrogenation ratio of 50 wt. % or less.

Component (I) of the present invention is available by anionic living polymerization in a hydrocarbon solvent in the presence of an initiator such as an organic alkali metal compound. Examples of the hydrocarbon solvent usable include aliphatic hydrocarbons such as n-butane, isobutane, n-pentane, n-hexane, n-heptane and n-octane, alicyclic hydrocarbons such as cyclopentane, methylcyclopentane, cyclohexane, methylcyclohexane, cycloheptane and methylcycloheptane, and aromatic hydrocarbons such as benzene, toluene, xylene and ethylbenzene. They may be used either singly or as a mixture of two or more thereof.

As the polymerization initiator, usable are aliphatic hydrocarbon alkali metal compounds, aromatic hydrocarbon alkali metal compounds, organic aminoalkali metal compounds and the like which are typically known to have anionic polymerization activity on conjugated dienes and vinyl aromatic compounds. Examples of the alkali metal include lithium, sodium, and potassium. As the organic alkali metal compounds, aliphatic and aromatic hydrocarbon lithium compounds having from 1 to 20 carbon atoms and containing, in one molecule thereof, one lithium atom or two or more lithium atoms are preferred. The latter compounds having two or more lithium atoms in one molecule are, for example, dilithium, trilithium and tetralithium compounds. Specific examples include n-propyllithium, n-butyllithium, sec-butyllithium, tert-butyllithium, hexamethylenedilithium, butadienyldilithium, isoprenyldilithium, and a reaction product of diisopropenylbenzene and sec-butyllithium, and a reaction product of divinylbenzene, sec-butyllithium and a small amount of 1,3-butadiene. Further, organic alkali metal compounds disclosed in U.S. Pat. No. 5,708,092, British Patent No. 2,241,239, U.S. Pat. No. 5,527,753 and the like can also be used. They may be used either singly or as a mixture of two or more thereof.

In the present invention, the polymerization temperature in the production of the block copolymer before hydrogenation is usually from −10° C. to 150° C., preferably from 40° C. to 120° C. The time required for polymerization is typically within 10 hours, especially preferably from 0.5 to 5 hours, though it varies depending on the conditions. Further, as the atmosphere of the polymerization system, it is desirable to purge with an inert gas such as nitrogen gas. The polymerization pressure is not particularly limited, and polymerization may be performed under a pressure enough for maintaining the monomers and solvent in a liquid phase in the above-described polymerization temperature range. Furthermore, it is necessary to take care so as not to allow impurities such as water, oxygen, or carbon dioxide gas that inactivate the catalyst and living polymer to enter in the polymerization system.

The hydrogenated block copolymer as Component (I) of the present invention is obtained by hydrogenating the block copolymer before hydrogenation obtained above. No particular limitation is imposed on a hydrogenation catalyst and conventionally known ones are usable, for example, (1) a support type heterogeneous hydrogenation catalyst having a metal such as Ni, Pt, Pd or Ru supported on carbon, silica, alumina, diatomaceous earth or the like, (2) a so-called Ziegler type hydrogenation catalyst using an organic acid salt of Ni, Co, Fe, Cr or the like or a transition metal salt such as acetylacetone salt and a reducing agent such as organoaluminum, and (3) a homogeneous hydrogenation catalyst such as so-called organic metal complex, e.g., an organic metal compound of Ti, Ru, Rh, Zr or the like. As specific examples, the hydrogenation catalysts described in Japanese Patent Publication Nos. Sho 42-8704, Sho 43-6636, Sho 63-4841, Hei 1-37970, Hei 1-53851 and Hei 2-9041 are usable. Titanocene compounds and/or mixtures thereof with a reducing organic metal compounds are preferably hydrogenation catalysts.

As the titanocene compounds, compounds described in Japanese Patent Laid-Open No. Hei 8-109219 are usable. Specific examples include compounds having at least one ligand having a (substituted) cyclopentadienyl skeleton, indenyl skeleton or fluorenyl skeleton, such as biscyclopentadienyltitanium dichloride and monopentamethylcydopentadienyltitanium trichloride. Examples of the reducing organic metal compound include organic alkali metal compounds such as organolithium, organomagnesium compounds, organoaluminum compounds, organoboric compounds, and organozinc compounds.

The hydrogenation reaction is usually conducted within a temperature range of from 0 to 200° C., preferably from 30 to 150° C. The pressure of hydrogen used in the hydrogenation reaction is recommended to be from 0.1 to 15 MPa, preferably from 0.2 to 10 MPa, more preferably from 0.3 to 7 MPa. The hydrogenation reaction time is typically from 3 minutes to 10 hours, preferably from 10 minutes to 5 hours. For the hydrogenation reaction, any one of a batch process, a continuous process and a combination thereof can be used.

In the hydrogenated block copolymer of the present invention, a hydrogenation ratio of unsaturated double bonds of the conjugated diene can be selected freely depending on the using purpose and is not particularly limited. In order to obtain a hydrogenated block copolymer having good heat stability and weather resistance, a hydrogenation ratio is recommended to 70% or greater, preferably 75% or greater, more preferably 85% or greater, especially preferably 90% or greater of the unsaturated double bonds of the conjugated diene compound in the hydrogenated block copolymer. In order to obtain a hydrogenated block copolymer having good heat stability, on the other hand, a hydrogenation ratio is preferably from 3 to 70%, more preferably from 5 to 65%, especially preferably from 10 to 60%. Although no particular limitation is imposed on the hydrogenation ratio of aromatic double bonds of the vinyl aromatic hydrocarbon in the hydrogenated block copolymer, it is preferred to adjust a hydrogenation ratio to not greater than 50%, preferably not greater than 30%, more preferably not greater than 20%. The hydrogenation ratio can be determined by a nuclear magnetic resonance apparatus (NMR).

In the present invention, a microstructure (cis, trans and vinyl contents) of the conjugated diene portion of the hydrogenated block copolymer can be changed freely by the use of the above-described polar compound or the like without particular limitation. In general, a vinyl bond content can be set within a range of from 5 to 90%, preferably from 10 to 80%, more preferably from 15 to 75%. The term “vinyl bond content” as used herein means a total content of 1,2-vinyl bonds and 3,4-vinyl bonds (provided that it is a 1,2-vinyl content when 1,3-butadiene is used as the conjugated diene). The vinyl bond content can be determined by a nuclear magnetic resonance apparatus (NMR).

### [Component (II)]

Component (II) of the present invention is at least one compound selected from the following compounds (i) to (iv):

(i) a block copolymer composed of a vinyl aromatic hydrocarbon and a conjugated diene or a hydrogenated product thereof, which is different from the block copolymer or hydrogenated product thereof (I),

(ii) a copolymer composed of a vinyl aromatic hydrocarbon and an aliphatic unsaturated carboxylic acid derivative,

(iii) a vinyl aromatic hydrocarbon polymer, and

(iv) a rubber-modified styrene polymer.

Examples of the polymer structure (polymer structure before hydrogenation in the case of a hydrogenated product) of the block copolymer composed of a vinyl aromatic hydrocarbon and a conjugated diene or a hydrogenated product thereof which is different from the block copolymer or hydrogenated product thereof (I) (which may hereinafter be called “Component (i)”) usable in the present invention include linear block copolymers represented by the following formulas:

(Ab-Bb)ₙ, Ab-(Bb-Ab)ₙ, Bb-(Ab-Bb)ₙ₊₁

(wherein, n stands for an integer of 1 or greater, usually from 1 to 5), radial block copolymers represented by the following formulas:

[(Ab-Bb)ₖ]ₘ₊₂-X, [(Ab-Bb)ₖ-Ab]ₘ₊₂-X,

[(Bb-Ab)ₖ]ₘ₊₂-X, [(Bb-Ab)ₖ-Bb]ₘ₊₂-X

(wherein, Ab is a polymer block composed mainly of a vinyl aromatic hydrocarbon, Bb is a polymer composed mainly of a conjugated diene, the boundaries between a block Ab and a block Bb are not necessarily dearly distinguished, X represents a residue of a coupling agent such as silicon tetrachloride, tin tetrachloride, 1,3-bis(N,N-glycidylaminomethyl)cyclohexane or epoxidized soybean oil, or a residue of an initiator such as a polyfunctional organolithium compound, and k and m stand for an integer from 1 to 5) and arbitrary mixtures of the polymer structures of these block copolymers. The vinyl aromatic hydrocarbon content of Component (i) is from 20 to 90 wt. %, preferably from 25 to 80 wt. %, more preferably from 30 to 75 wt. %. With regard to the molecular weight of Component (i), the number average molecular weight determined by gel permeation chromatography (GPC) with polystyrene standards is from 30000 to 500000, preferably from 50000 to 500000, more preferably from 70000 to 300000. Component (i) may be a mixture of block copolymers different in molecular weight. The number average molecular weight can be adjusted freely by the amount of a catalyst used for polymerization.

The vinyl aromatic hydrocarbon of the copolymer composed of a vinyl aromatic hydrocarbon and an aliphatic unsaturated carboxylic acid derivative (which copolymer may be hereinafter be called “Component (ii)”) to be used in the present invention is the above-described styrene monomer, while the aliphatic unsaturated carboxylic acid derivative is at least one derivative selected from acrylic acid, ester derivatives between a C₁₋₁₃, preferably C₂₋₁₃ alcohol and acrylic acid such as methyl acrylate, ethyl acrylate, propyl acrylate, butyl acrylate, pentyl acrytate and hexyl acrylate, methacrylic acid, and similar ester derivatives between a C₁₋₁₃, preferably C₂₋₁₃, more preferably C₃₋₁₃ alcohol and methacrylic acid, α,β-unsaturated dicarboxylic acids such as fumaric acid, itaconic acid and maleic acid, and mono- or di-ester derivatives between the dicarboxylic acid and a C₂₋₁₃ alcohol. The aliphatic unsaturated carboxylic acid derivative is usually composed mainly of the above-described ester and its amount is preferably 50 mole % or greater, more preferably 70 mole % or greater. As for its kind, the derivative composed mainly of the ester, preferably ethyl acrylate, propyl acrylate, butyl acrylate, hexyl acrylate or octyl acrylate is preferred.

Component (ii) can be produced by a known production process for styrene resins, for example, bulk polymerization, solution polymerization, suspension polymerization, or emulsion polymerization. A polymer having a weight average molecular weight of usually from 50000 to 500000 is usable.

The copolymer composed of a vinyl aromatic hydrocarbon and an aliphatic unsaturated carboxylic acid derivative is especially preferably a copolymer composed mainly of styrene and n-butyl acrylate, more specifically, a copolymer of an aliphatic unsaturated carboxylate and styrene containing n-butyl acrylate and styrene in a total amount of 50 wt. % or greater, more preferably 60 wt. % or greater. A heat shrinkable film using the copolymer of an aliphatic unsaturated carboxylate and styrene composed mainly of n-butyl acrylate and styrene has good shrink properties.

The vinyl aromatic hydrocarbon polymer (iii) (which may hereinafter be called “Component (iii)”) to be used in the present invention is available by polymerizing a vinyl aromatic hydrocarbon or a monomer copolymerizable therewith (excluding Component (ii)). The vinyl aromatic hydrocarbon is mostly a styrene monomer, more specifically, that selected from styrene, α-alkyl-substituted styrenes such as α-methylstyrene, nucleus alkyl-substituted styrenes and nucleus halogen-substituted styrenes. A proper one may be selected depending on the using purpose. Examples of the monomer copolymerizable with the vinyl aromatic hydrocarbon include acrylonitrile and maleic anhydride. Examples of the vinyl aromatic hydrocarbon polymer include polystyrene, styrene-α-methylstyrene copolymer, acrylonitrile-styrene copolymer, and styrene-maleic anhydride copolymer. Of these, polystyrene is an especially preferred vinyl aromatic hydrocarbon polymer. The vinyl aromatic hydrocarbon polymers having a weight average molecular weight of typically from 50000 to 500000 are usable. These vinyl aromatic hydrocarbon polymers may be used either singly or as a mixture of two or more thereof and can be used as a rigidity improver.

The rubber-modified styrene polymer (iv) (which may hereinafter be called “Component (iv)”) to be used in the present invention is obtained by polymerizing a mixture of a vinyl aromatic hydrocarbon or a monomer copolymerizable therewith and an elastomer copolymerizable with the vinyl aromatic hydrocarbon. Polymerization is usually performed by suspension polymerization, emulsion polymerization, bulk polymerization, bulk-suspension polymerization or the like. Examples of the vinyl aromatic hydrocarbon and monomer copolymerizable therewith include α-methylstyrene, acrylonitrile, an acrylate, a methacrylate, and maleic anhydride, while those of the elastomer copolymerizable with the vinyl aromatic hydrocarbon include natural rubber, synthetic isoprene rubber, butadiene rubber, styrene-butadiene rubber, and high styrene rubber.

The elastomer is provided for emulsion polymerization, bulk polymerization, bulk-suspension polymerization or the like in the form of a solution or latex obtained by dissolving from 3 to 50 parts by weight of it in 100 parts by weight of the vinyl aromatic hydrocarbon or the monomer copolymerizable therewith. Particularly preferred rubber-modified styrene polymer is an impact-resistant rubber-modified styrene polymer (HIPS). The rubber-modified styrene polymer can be utilized as an improver for rigidity, impact resistance and slip properties. The rubber-modified styrene polymers having a weight average molecular weight of typically from 50000 to 500000 are usable. The rubber modified styrene polymer is added preferably in an amount of from 0.1 to 10 parts by weight in order to maintain transparency.

Components (i) to (iv) to be used in the present invention are recommended to have an MFR (under condition G, temperature: 200° C., load: 5 Kg) of from 0.1 to 100 g/10 min, preferably from 0.5 to 50 g/10 min, and from 1 to 30 g/10 min from the viewpoint of moldability or formability.

### [Composition A]

The composition of the present invention composed of Component (I) and Component (II) (which may hereinafter be called “Composition A of the present invention”) has Component (I) and Component (II) at a weight ratio of from 99/1 to 10/90, preferably 97/3 to 20/80, more preferably from 95/5 to 30/70. When the Component (i)/Component (II) weight ratio falls within a range of from 99/1 to 10/90, a heat shrinkable film available using it has excellent in the balance of rigidity and elongation.

The vinyl aromatic hydrocarbon content of Composition A of the present invention is preferably from 75 to 85 wt. %, more preferably from 76 to 82.5 wt. %. When the vinyl aromatic hydrocarbon content falls within a range of from 75 to 85 wt. %, the physical property balance between rigidity and elongation is excellent. The vinyl aromatic hydrocarbon content can be controlled by adjusting the vinyl aromatic hydrocarbon content in Components (I) and (II) and their weight ratio.

Composition A of the present invention can be produced by any conventionally known mixing method. Examples include a melt-kneading method using a typical mixer such as open roll, intensive mixer, internal mixer, co-kneader, continuous kneader equipped with a twin rotor, or extruder and a method of dissolving or dispersing each component in a solvent, mixing the resulting solution or dispersion, and then removing the solvent by heating.

### [Material]

Component (I) of the present invention or Composition A composed of Components (I) and (I) of the present invention (which may hereinafter be called “Material of the present invention”, collectively) has a storage elastic modulus (E′) at 50° C. of from 0.7×10⁹ to 2.5×10⁹ Pa, preferably from 0.8×10⁹ to 2.0×10⁹ Pa, more preferably from 0.9×10⁹ to 1.8×10⁹ Pa. When the storage elastic modulus (E′) at 50° C. falls within a range of from 0.7×10⁹ to 2.5×10⁹ Pa, the physical property balance between rigidity and elongation is excellent. The storage elastic modulus (E′) at 50° C. can be controlled by measuring the vinyl aromatic hydrocarbon contents of Components (I) and (II) or the storage elastic moduli (E′) of Components (I) and (II) at 50° C. in advance and adjusting their weight ratio.

A heat shrinkable film having improved blocking resistance can be obtained by adding, to 100 parts by weight of the Material of the present invention, from 0.01 to 5 parts by weight, preferably from 0.05 to 4 parts by weight, more preferably from 0.1 to 3 parts by weight of at least one lubricant selected from fatty acid amides, paraffins, hydrocarbon resins and fatty acids. When Composition A is used as the Material of the present invention, the lubricant may be added to either Component (I) or (II) in advance or may be added after preparation of Composition A.

Examples of the fatty acid amide include stearamide, oleylamide, erucylamide, behenamide, a mono- or bisamide of a higher fatty acid, ethylenebisstearamide, stearyloleylamide, and N-stearylerucamide. They may be used either singly or as a mixture of two or more thereof. Examples of the paraffin and hydrocarbon resin include paraffin wax, microcrystalline wax, liquid paraffin, paraffin synthetic wax, polyethylene wax, composite wax, montan wax, hydrocarbon wax, and silicone oil. They may be used either singly or as a mixture of two or more thereof.

Examples of the fatty acid include saturated fatty acids and unsaturated fatty acids, more specifically, saturated fatty acids such as lauric acid, palmitic acid, stearic acid, behenic acid and hydroxystearic acid and unsaturated fatty acids such as oleic acid, erucic acid and ricinolic acid. These can be used either singly or as a mixture of two or more thereof.

A heat shrinkable film having improved light resistance can be obtained by adding, to 100 parts by weight of the Material of the present invention, from 0.05 to 3 parts by weight, preferably from 0.05 to 2.5 parts by weight, more preferably from 0.1 to 2 parts by weight of at least one ultraviolet absorber and light stabilizer selected from benzophenone ultraviolet absorbers, benzotriazole ultraviolet absorbers and hindered amine light stabilizers. When Composition A is used as the Material of the present invention, the ultraviolet absorber and light stabilizer may be added to either one of Component (I) or (II) in advance or may be added after preparation of Composition A.

Examples of the benzophenone ultraviolet absorbers include 2,4-dihydroxybenzophenone, 2-hydroxy-4-methoxybenzophenone, 2,2′-dihydroxy-4-methoxybenzophenone, 2,2′-dihydroxy-4,4′-dimethoxybenzophenone, 2-hydroxy-4-n-octoxybenzophenone, 2,2′,4′4-tetrahydroxybenzophenone, 4-dodecyloxy-2-hydroxybenzophenone, 3,5-di-t-butyl-4-hydroxybenzoylic acid, n-hexadecyl ester, bis(5-benzoyl-4-hydroxy-2-methyoxyphenyl)methane, 1,4-bis(4-benzoyl-3-hydroxyphenoxy)butane, and 1,6-bis(4-benzoyl-3-hydroxyphenoxy)hexane.

Examples of the benzotriazole ultraviolet absorbers include 2-(2′-hydroxy-5′-methyl-phenyl)benzotriazole, 2-(2′-hydroxy-3′,5′-di-t-butyl-phenyl)benzotriazole, 2-(2′-hydroxy-3′-t-butyl-5′-methyl-phenyl)-5-chlorobenzotriazole, 2-(2′-hydroxy-3′,5′-di-t-butyl-phenyl)-5-chlorobenzotriazole, 2-(2′-hydroxy-5′-t-octylphenyl)benzotriazole, 2-(2′-hydroxy-3′,5′-di-t-amylphenyl)benzotriazole, 2-[2′-hydroxy-3′-(3′,4′,5′,6′-tetrahydrophthalimidomethyl)-5′-methylphenyl]benzotriazole, 2-2′-methylenebis[4-(1,1,3,3-tetramethylbutyl)-6-(2H-benzotriazol-2-yl)phenol], 2-[2-hydroxy-3,5-bis(α,α-dimethylbenzyl)phenyl]-2H-benzotriazole, 2-(2-hydroxy-4-octyloxyphenyl)-2H-benzotriazole, 2-(2H-benzotriazol-2-yl)-4-methyl-6-(3,4,5,6-tetrahydrophthalimidylmethyl)phenol.

Examples of the hindered amine light stabilizers include bis(2,2,6,6-tetramethyl-4-piperidyl)sebacate, bis-(1,2,6,6,6,-penmethyl-4-pipenidyl)sebacate, 1-[2-{3-(3,5-di-tertiary butyl-4-hydroxyphenyl)propionyloxy}-ethyl]-4-{3-(3,5-di-tertiary butyl-4-hydroxyphenyl)propionyloxy}-2,2,6,6-tetramethylpiperidine, 8-acetyl-3-dodecyl-7,7,9,9-tetramethyl-1,3,8-triazaspiro[4,5]decane-2,4-dione, 4-benzoyloxy-2,2,6,6-tetramethylpiperidine, and (dimethyl succinate)-1-(2-hydroxyethyl)-4-hydroxy-2,2,6,6-tetramethylpiperidine polycondensate.

Additional examples include poly[[6-1,1,3,3-tetramethylbutyl)imino-1,3,5-triazine-2,4-diyl][(2,2,66-tetramethyl-4-piperidyl)imino]hexamethylene[[2,2,6,6-tetramethyl-4-piperidyl)imino]], poly[6-morpholino-s-triazine-2,4-diyl][(2,2,6,6-tetramethyl-4-piperidyl)imino]-hexamethylene[(2,2,6,6-tetramethyl-4-piperidyl)imino]], 2-(3,5-di-tertiary butyl-4-hydroxybenzyl)-2-n-(butylmalonic acid)bis(1,2,2,6,6-pentamethyl-4-piperidyl), tetraxy(2,2,6,6-tetramethy-4-piperidyl)1,2,3,4-butane tetracarboxylate, tetraxy(1,2,2,6,6-pentamethyl-4-piperidyl) 1,2,3,4-butane tetracarboxylate and condensate of 1,2,3,4-butanetetracarboxylic acid, 1,2,2,6,6-pentamethyl-4-piperidinol and tidecyl alcohol.

Further additional examples include condensate of 1,2,3,4-butanetetracarboxylic acid, 2,2,6,6-tetramethyl-4-piperidinol and tridecyl alcohol, condensate of 1,2,3,4-butanetetracarboxylic acid, 1,2,2,6,6-pentamethyl-4-piperidinol and β,β,β,β-tetramethyl-3,9-(2,4,8,10-tetraoxaspiro[5,5]undecane)diethanol, condensate of 1,2,3,4-butanetetracarboxylic acid, 2,2,6,6-tetramethyl-4-piperidinol and β,β,β,β-tetramethyl-3,9-(2,4,8,10-tetraoxaspiro[5,5]undecane)diethanol, N,N′-bis(3-aminopropyl)ethylenediamine-2,4-bis[N-butyl-N-(1,2,2,6,6-pentamethyl-4-piperidyl)amino]-6-chloro-1,3,5-triazine condensate, dibutylamine-1,3,5-triazine-N,N-bis(2,2,6,6-tetramethyl-4-piperidyl-1,6-hexamethylenediamine N-2,2,6,6-tetramethy-4-piperidyl)butylamine polycondensate, 1,2,2,6,6-tetramethyl-4-piperidyl methacrylate, and 2,2,6,6-tetramethyl-4-piperidyl methacrylate.

Addition of from 0.005 to 3 parts by weight, more preferably from 0.1 to 2 parts by weight of 2-[1-(2-hydroxy-3,5-di-t-pentylphenyl)ethyl]-4,6-di-t-pentylphenyl acrylate as a stabilizer to 100 parts by weight of the Material of the present invention is effective for suppressing gelation. Addition of the stabilizer in an amount less than 0.05 part by weight is not effective for suppressing gelation, while addition of it in an amount exceeding 3 parts by weight does not bring about a gelation suppressing effect higher than that of the present invention. When Composition A is used as the Material of the present invention, the stabilizer may be added in advance to either one of Component (I) or (II), or may be added after preparation of Composition A.

To 100 parts by weight of the Material of the present invention, from 0.05 to 3 parts by weight of at least one phenolic stabilizer such as n-octadecyl-3-(3,5-di-t-butyl-4-hydroxyphenyl)propionate, 2-t-butyl-6-(3-t-butyl-2-hydroxy-5-methylbenzyl)-4-methylphenyl acrylate, 2,4-bis[(octylthio)methyl]-o-cresol, tetrakis[methylene-3-(3,5-di-t-butyl-4-hydroxyphenyl)propionate]methane, 1,3,5-trimethyl-2,4,6-tris(3,5-di-t-butyl-4-hydroxybenzyl)benzene or 2,4-bis-(n-octylthio)-6-(4-hydroxy-3,5-di-t-butylanilino)-1,3,5-triazine can be added and from 0.05 to 3 parts by weight of at least one organic phosphate or organic phosphite stabilizer such as tris-(nonylphenyl)phosphite, 2,2-methylenebis(4,6-di-t-butylphenyl)octylphosphite, 2-[[2,4,8,10-tetrakis(1,1-dimethylethyl)dibenzo[d,f][1,3,2]dioxaphosphepin-6-yl]oxy]-N, N-bis[2-[[2,4,8,10-tetrakis(1,1-dimethylethyl)dibenzo[d,f][1,3,2]dioxaphosphepin-6-yl]oxy]ethyl]ethaneamine and tris(2,4-di-t-butylphenyl)phosphite.

Various additives can be added to the Material of the present invention, depending on the using purpose. Preferred examples of the additives include softening agents and plasticizers such as coumarone-indene resins, terpene resins and oils. Further, various stabilizers, pigments, antiblocking agents, antistatic agents, lubricants and the like can also be added. Examples of the antiblocking agent, antistatic agent and lubricant include fatty acid amides, ethylenebis-stearamide, sorbitan monostearate, saturated fatty acid esters of a fatty acid alcohol, and pentaerythritol fatty acid esters, while those of the ultraviolet absorber include compounds described in Practical Handbook of Additives for Plastics and Rubbers (Kagaku Kogyosha) such as p-t-butylphenyl salicylate, 2-(2′-hydroxy-5′-methylphenyl)benzotriazole, 2-(2′-hydroxy-3′-t-butyl-5′-methylphenyl)-5-chlorobenzotriazole and 2,5-bis-[5′-t-butylbenzoxazolyl-(2)]thiophene. These additives are added typically in an amount ranging from 0.01 to 5 wt. %, preferably from 0.05 to 3 wt. %.

As a result of measurement of the molecular weight of the Material of the present invention by gel permeation chromatography (GPC), a proportion of the molecular weight of 200000 or greater is from 15 to 70 wt. %, preferably from 20 to 65 wt. %, more preferably form 25 to 60 wt. %. When a ratio of the molecular weight of 200000 or greater falls within a range of from 15 to 70 wt. %, a heat shrinkable film having a uniform film thickness and excellent in stability in extrusion molding film is available. The proportion of the molecular weight of 200000 or greater of the Material of the present invention as measured by GPC measurement can be controlled by adjusting the proportions of the molecular weight of 200000 or greater of Components (I) and (II).

### [Production Process of Heat Shrinkable Film]

The production process of the heat shrinkable film according to the present invention comprises a first inflation step for forming a sheet in raw form to be stretched and a second inflation step of subjecting the sheet to inflation again in a liquid. The first step and second step are performed successively.

### <First Inflation Step>

In the first inflation step, a tube having a thickness of from 0.05 to 0.5 mm, preferably from 0.1 to 0.3 mm is formed by setting the temperature of a dice for inflation at from 150 to 250° C., preferably from 160 to 220° C. A raw sheet tube to be stretched is produced while setting a ratio of the diameter of an annular dice to the diameter of the raw sheet tube (which will hereinafter be called “first blow-up ratio”) at from 1 to 5, a ratio of a discharge rate from the dice to a take-up rate of a take-up roll (which will hereinafter be called “first draft ratio”) at from 1 to 15, preferably from 1 to 10, and a total deformation ratio (first blow-up ratio×first draft ratio) at from 1 to 75, preferably from 1 to 50. At the first draft ratios falling within a range of from 1 to 15, shrinkage in the machine direction is small and finish of the resulting film used for covering is excellent.

### <Second Inflation Step>

In the second inflation step, the raw sheet to be stretched is stretched by using an inflation method again to from 1.5 to 5 times its original length along TD in a fluid of from 65 to 100° C., preferably from 68 to 95° C., more preferably from 70 to 87° C., especially preferably from 73 to 85° C., whereby a heat shrinkable film having a shrinkage ratio, at 90° C. for 5 seconds, of 20% or less along the machine direction (MD) and from 20 to 60% along the transverse direction (TD). Stability in extrusion molding film is excellent at the fluid temperature of from 65 to 90° C. A draw ratio of the sheet is from 1.5 to 5, preferably from 1.7 to 4, more preferably from 2 to 3. When the draw ratio is from 1.5 to 5, the resulting heat shrinkable film shows excellent finish when a bottle or the like is covered therewith. The draw ratio along TD can be controlled by adjusting a ratio of the diameter of the raw sheet tube to the diameter of the heat shrinkable film (which will hereinafter be called “second blow-up ratio”). The second blow-up ratio is from 1.5 to 5, preferably from 1.7 to 4.5, more preferably from 2 to 4. A ratio of the take-up roll rate in the first inflation step to a take-up roll rate of a heat shrinkable film in the second inflation step (which will hereinafter be called “second draft ratio”) is from 0.8 to 1.5.

The term “fluid” as used herein means a liquid having a viscosity of 100 centipoise (CP) or less at a stretching and film forming temperature. No particular limitation is imposed on the kind of the fluid and examples of it include water, mineral oils, glycerin, alcohols and nonionic surfactants. Of these, water is preferred and water may contain soap, surfactant or the like.

### [Heat Shrinkable Film]

The heat shrinkable film of the present invention has a shrinkage ratio, at 90° C. for 5 seconds, of 20% or less, preferably 15% or less, more preferably 10% or less in the machine direction (MD) and from 20 to 60%, preferably from 25 to 60%, more preferably from 30 to 60% in the transverse direction (TD). The heat shrinkable film having a shrinkage ratio, for 5 seconds, of 20% or less in the machine direction (MD) and from 20 to 60% in the transverse direction. (TD) shows excellent finish when a bottle or the like is covered therewith. The shrinkage ratio in the machine direction (MD) can be controlled by adjusting the first and second draft ratios, while that in the transverse direction (TD) can be controlled by adjusting the temperature of the fluid and second blow-up ratio.

The heat shrinkable film of the present invention may be a multilayer laminate film having a structure of at least two layers, preferably at least three layers. Specific examples of the using form of it as the multilayer laminate include that disclosed in Japanese Patent Publication No. Hei 3-5306. The heat shrinkable film of the present invention may be used as an intermediate layer or outer layers on both sides. When the heat shrinkable film of the present invention is used as an intermediate layer, an outer layer film has preferably a Vicat softening point higher by from 3 to 15° C., preferably from 5 to 12° C. than that of the intermediate layer.

When the heat shrinkable film of the present invention is used for a multilayer film, no particular limitation is imposed on layers other than the layer of the heat shrinkable film of the present invention. The multilayer film may be made of a block copolymer and/or hydrogenated product thereof other than those used in the present invention or a composition having the block copolymer and/or hydrogenated product thereof other than those used in the present invention and the above-described vinyl aromatic hydrocarbon polymer. In addition, at least one component selected from polypropylene, polyethylene, ethylene polymers (ethylene-vinyl acetate copolymer, ethylene-ethyl acrylate copolymer and ethylene-acrylic acid copolymer), ionomer resins, nylon resins, polyester resins, poly(methyl methacrylate) resins, ABS resins and the above-described vinyl aromatic hydrocarbon polymers is usable. Preferred are the block copolymer and/or hydrogenated product thereof other than those used in the present invention, the composition having the block copolymer and/or hydrogenated product thereof other than those used in the present invention and the vinyl aromatic hydrocarbon polymer, and the above-described vinyl aromatic hydrocarbon polymer.

The thickness of the heat shrinkable film and heat shrinkable multilayer film of the present invention is from 10 to 300 μm, preferably from 20 to 200 μm, more preferably from 30 to 100 μm. A thickness ratio of the surface layers on both sides of the multilayer film to the inner layer is recommended to be from 5/95 to 45/55, preferably from 10/90 to 35/65.

The heat shrinkable film of the present invention can be used for various applications, for example, packages of fresh food and confectionery and packages of clothes, stationery and the like. It is particularly preferred when employed as a material for so-called heat shrinkable labels to be used by adhering a uniaxially stretched film made of the block copolymer specified in the present invention on which letters or designs have been printed to a surface of an article to be packaged such as plastic molding, metal product, glass vessel or porcelain, while applying heat to cause heat shrinkage.

In particular, the heat shrinkable film of the present invention is excellent in transparency and rigidity so that it can be suitably utilized as, as well as a material for heat shrinkable labels for plastic moldings which undergo deformation when heated to high temperatures, a material for heat shrinkable labels for vessels made of at least one material selected from metals, porcelain, glass, paper, polyolefin resins such as polyethylene, polypropylene and polybutene, polymethacrylate resins, polycarbonate resins, polyester resins such as polyethylene terephthalate and polybutylene terephthalate and polyamide resins that are extremely different from the block copolymer of the present invention in a coefficient of thermal expansion, water absorption properties or the like.

Examples of the material constituting plastic vessels for which the heat shrinkable film of the present invention can be attached include, as well as the above-described resins, polystyrene, rubber-modified high-impact polystyrene (HIPS), styrene-butyl acrylate copolymers, styrene-acrylonitrile copolymers, styrene-maleic anhydride copolymers, acrylonitrile-butadiene-styrene copolymers (ABS), methacrylate-butadiene-styrene copolymers (MBS), polyvinyl chloride resins, polyvinyl chloride resins, phenol resins, urea resins, melamine resins, epoxy resins, unsaturated polyester resins and silicone resins. These plastic vessels may each be made of either a mixture of two or more of the resins or a laminate thereof.

### [Component (III)]

The block copolymer or hydrogenated product thereof (III) according to the present invention (which may hereinafter be called “Component (III)”) has a vinyl aromatic hydrocarbon content of from 65 to 95 wt. %, preferably from 70 to 90 wt. %, more preferably from 73 to 85 wt. %, while it has a conjugated diene content of from 5 to 35 wt. %, preferably from 10 to 30 wt. %, more preferably from 15 to 27 wt. %. When the vinyl aromatic hydrocarbon content and the conjugated diene content fall within ranges of from 65 to 95 wt. % and from 5 to 35 wt. %, respectively, the balance between rigidity and elongation is excellent. The vinyl aromatic hydrocarbon content of the hydrogenated block copolymer may be considered as that of the block copolymer before hydrogenation.

Component (III) has a storage elastic modulus (E′) at 30° C. of 3×10⁸ Pa or greater, preferably 5×10⁸ or greater, more preferably 8×10⁸ or greater. When the storage elastic modulus (E′) at 30° C. is 3×10⁸ or greater, the balance between rigidity and elongation is excellent. The storage elastic modulus (E′) at 30° C. can be controlled by adjusting a ratio of the vinyl aromatic hydrocarbon to the conjugated diene, the amount of the vinyl aromatic hydrocarbon block in the block copolymer, the copolymer block amount of the vinyl aromatic hydrocarbon and conjugated diene.

The peak temperature of the loss elastic modulus (E″) of Component (III) is 60° C. or greater but not greater than 110° C., preferably from 65 to 105° C., more preferably from 70 to 100° C. When Component (III) has at least one peak temperature of the loss elastic modulus (E′) within a range of 60° C. or greater but not greater than 110° C., the resulting film is excellent in heat shrink properties. The peak temperature of the loss elastic modulus (E″) can be controlled by adjusting the molecular weight of the block copolymer, amount of vinyl aromatic hydrocarbon blocks, or copolymer block amount of the vinyl aromatic hydrocarbon and conjugated diene.

Component (II) is composed of Component (a) and Component (b). Component (a) has at least one peak molecular weight as measured by gel permeation chromatography (GPC) within a range of from 30000 to 300000, preferably from 50000 to 250000, still more preferably from 80000 to 230000. Component (b) has at least one peak molecular weight as measured by GPC within a range exceeding 300000 but not greater than 1000000, preferably a range exceeding 350000 but not greater than 900000, still more preferably a range from 400000 to 850000. A Component (a)/Component (b) weight ratio is from 10/90 to 90/10, preferably from 15/85 to 85/15, more preferably from 20/80 to 80/20. When Component (a) has at least one peak molecular weight within a range of from 30000 to 300000, Component (b) has at least one peak molecular weight within a range exceeding 300000 but not greater than 1000000 and a Component (a)/Component (b) weight ratio falls within a range of from 10/90 to 90/10, Component (III) is excellent in moldability or formability and low-temperature elongation of a stretched film. The peak molecular weight of Component (a) can be controlled by adjusting the amount of an initiator, while that of Component (b) can be controlled by adjusting the peak molecular weight of Component (a) and a coupling ratio.

Component (a) and Component (b) each has at least one segment constituted by a vinyl aromatic hydrocarbon homopolymer and/or a copolymer composed of a vinyl aromatic hydrocarbon and a conjugated diene, and at least one segment constituted by a conjugated diene homopolymer and/or a copolymer composed of a vinyl aromatic hydrocarbon and a conjugated diene. The segments constituting Component (a) and those constituting Component (b) may be the same or different. One of the preferred preparation process is to add a trifunctional or higher multifunctional coupling agent in an amount not greater than the equivalent to the amount of the initiator of Component (a), thereby forming Component (b) at an active end of Component (a). Alternatively, Component (b) having a polymer structure different from that of Component (a) may be blended with Component (a).

Although there is no particular limitation on the polymer structure, Component (b) has a polymer structure polymerized by a trifunctional or higher multifunctional coupling agent. Component (b) having a polymer structure polymerized by a trifunctional or higher multifunctional coupling agent contributes to excellent film forming stability and low-temperature elongation. As a polymer structure suited for Component (a) and Component (b), a linear block copolymer or radial block copolymer represented by the following formulas or any mixture of these polymer structures are usable. In the radial block copolymer represented by the following formula, at least one of Segment A and/or B may be bonded to X further.

(A-B)ₙ, A-(B-A)ₙ, B-(A-B)ₙ₊₁,

(A-B)ₖ]ₘ₊₁-X, [(A-B)ₖ-A]ₘ₊₁-X,

(B-A)ₖ]ₘ₊₁-X and [(B-A)ₖ-B]ₘ₊₁-X

(wherein, Segment A is a vinyl aromatic hydrocarbon homopolymer and/or a copolymer composed of a vinyl aromatic hydrocarbon and a conjugated diene; Segment B is a conjugated diene homopolymer and/or a copolymer composed of a vinyl aromatic hydrocarbon and a conjugated diene; X represents a residue of a coupling agent such as silicon tetrachloride, tin tetrachloride, 1,3-bis(N,N-glycidylaminomethyl)cyclohexane or epoxidized soybean oil, or a residue of an initiator such as a polyfunctional organolithium compound; and n, k and m stand for an integer of 1 or greater, typically an integer from 1 to 5, with the proviso that structures of a plurality of polymer chains bonded to X may be the same or different).

In the present invention, the vinyl aromatic hydrocarbon in the copolymer of the vinyl aromatic hydrocarbon and conjugated diene in Segment A or Segment B may be distributed uniformly or in the tapered form (gradually diminishing form). Alternatively, the copolymer in Segment may have therein a plurality of uniformly distributed portions of the vinyl aromatic hydrocarbon and/or a plurality of portions distributed in the tapered form. With regard to the relationship between the vinyl aromatic hydrocarbon content in segment A ({the vinyl aromatic hydrocarbon in segment A/(the vinyl aromatic hydrocarbon+the conjugated diene in segment A)}×100) and the vinyl aromatic hydrocarbon content in segment B ({the vinyl aromatic hydrocarbon in segment B/(the vinyl aromatic hydrocarbon+the conjugated diene in segment B)}×100), the vinyl aromatic hydrocarbon content in segment A is larger than the vinyl aromatic hydrocarbon content in segment B. A preferred difference in the vinyl aromatic hydrocarbon content between segment A and segment B is preferably 5 wt. % or greater.

In the present invention, Component (III) is available by polymerizing a vinyl aromatic hydrocarbon and a conjugated diene in a hydrocarbon solvent in the presence of an organolithium compound as an initiator. Examples of the vinyl aromatic hydrocarbon to be used in the present invention include styrene, o-methylstyrene, p-methylstyrene, p-tert-butylstyrene, 1,3-dimethylstyrene, α-methylstyrene, vinylnaphthalene, vinylanthracene, 1,1-diphenylethylene, N,N-dimethyl-p-aminoethylstyrene, and N,N-diethyl-p-aminoethylstyrene. Of these, styrene is especially typical. They may be used either singly or as a mixture of two or more thereof.

The conjugated diene is a diolefin having a pair of conjugated double bonds. Examples thereof include 1,3-butadiene, 2-methyl-1,3-butadiene (isoprene), 2,3-dimethyl-1,3-butadiene, 1,3-pentadiene, and 1,3-hexadiene. Of these, 1,3-butadiene, isoprene and the like are especially typical. They may be used either singly or as a mixture of two or more thereof.

In Component (III) of the present invention, at least one polymer block selected from the group consisting of (1) a copolymer block composed of isoprene and 1,3-butadiene, (2) a copolymer block composed of isoprene and a vinyl aromatic hydrocarbon and (3) a copolymer block composed of isoprene, 1,3-butadiene and a vinyl aromatic hydrocarbon may be incorporated. A hydrogenated block copolymer composed of a block copolymer containing butadiene and isoprene at a weight ratio of from 3/97 to 90110, preferably from 5/95 to 85/15, more preferably from 19/90 to 80/20 does not form a lot of gels in thermoforming, processing and the like when it has a hydrogenation ratio of 50 wt. % or less.

Component (III) of the present invention is available by anionic living polymerization in a hydrocarbon solvent in the presence of an organic alkali metal compound or the like as an initiator. Examples of the hydrocarbon solvent usable include aliphatic hydrocarbons such as n-butane, isobutane; n-pentane, n-hexane, n-heptane and n-octane, alicyclic hydrocarbons such as cyclopentane, methylcyclopentane, cyclohexane, methylcyclohexane, cycloheptane and methylcydoheptane, and aromatic hydrocarbons such as benzene, toluene, xylene and ethylbenzene. They may be used either singly or as a mixture of two or more thereof.

As the polymerization initiator, usable are aliphatic hydrocarbon alkali metal compounds, aromatic hydrocarbon alkali metal compounds, organic aminoalkali metal compounds and the like which are generally known to have anionic polymerization activity to conjugated dienes and vinyl aromatic compounds. Examples of the alkali metal include lithium, sodium, and potassium. As the organic alkali metal compounds, aliphatic and aromatic hydrocarbon lithium compounds having from 1 to 20 carbon atoms and containing, in one molecule thereof, one lithium atom or two or more lithium atoms are preferred. The latter compounds having two or more lithium atoms in one molecule are, for example, dilithium, trilithium and tetralithium compounds. Specific examples include n-propyllithium, n-butyllithium, sec-butyllithium, tert-butyllithium, hexamethylenedilithium, butadienyldilithium, isoprenyldilithium, and a reaction product of diisopropenylbenzene and sec-butyllithium, and a reaction product of divinylbenzene, sec-butyllithium and a small amount of 1,3-butadiene.

Further, organic alkali metal compounds disclosed in U.S. Pat. No. 5,708,092, British Patent No. 2,241,239, U.S. Pat. No. 5,527,753 and the like can also be used. They may be used either singly or as a mixture of two or more thereof.

In the present invention, the polymerization temperature in the production of the block copolymer before hydrogenation is usually from −10° C. to 150° C., preferably from 40° C. to 120° C. The time required for polymerization is typically within 10 hours, especially preferably from 0.5 to 5 hours, though it varies depending on the conditions. Further, as the atmosphere of the polymerization system, it is desirable to purge with an inert gas such as nitrogen gas. The polymerization pressure is not particularly limited, and polymerization may be performed under a pressure enough for maintaining the monomers and solvent in a liquid phase in the above-described polymerization temperature range. Furthermore, it is necessary to take care so as not to allow impurities such as water, oxygen, and carbon dioxide gas that inactivate the catalyst and living polymer to enter in the polymerization system.

The hydrogenated block copolymer as Component (III) of the present invention is obtained by hydrogenating the block copolymer before hydrogenation which has been obtained above. No particular limitation is imposed on a hydrogenation catalyst and conventionally known ones are usable, for example, (1) a support type heterogeneous hydrogenation catalyst having a metal such as Ni, Pt, Pd or Ru supported on carbon, silica, alumina, diatomaceous earth or the like, (2) a so-called Ziegler type hydrogenation catalyst using an organic acid salt of Ni, Co, Fe, Cr or the like or a transition metal salt such as acetylacetone salt and a reducing agent such as organoaluminum, and (3) a homogeneous hydrogenation catalyst such as so-called organic metal complex, e.g., an organic metal compound of Ti, Ru, Rh, Zr or the like. As specific examples, the hydrogenation catalysts described in Japanese Patent Publication Nos. Sho 42-8704, Sho 43-6636, Sho 63-4841, Hei 1-37970, Hei 1-53851 and Hei 2-9041 are usable. Titanocene compounds and/or mixtures thereof with a reducing organic metal compounds are preferable hydrogenation catalysts.

As the titanocene compounds, compounds described in Japanese Patent Laid-Open No. Hei 8-109219 are usable. Specific examples include compounds having at least one ligand having a (substituted) cyclopentadienyl skeleton, indenyl skeleton or fluorenyl skeleton, such as biscyclopentadienyltitanium dichloride and monopentamethylcyclopentadienyltitanium trichloride. Examples of the reducing organic metal compound include organic alkali metal compounds such as organolithium, organomagnesium compounds, organoaluminum compounds, organoboric compounds, and organozinc compounds.

The hydrogenation reaction is usually conducted within a temperature range of from 0 to 200° C., preferably from 30 to 150° C. The pressure of hydrogen used in the hydrogenation reaction is recommended to be from 0.1 to 15 MPa, preferably from 0.2 to 10 MPa, more preferably from 0.3 to 7 MPa. The hydrogenation reaction time is typically from 3 minutes to 10 hours, preferably from 10 minutes to 5 hours. For the hydrogenation reaction, any one of a batch process, a continuous process and a combination thereof can be used.

In the hydrogenated block copolymer of the present invention, a hydrogenation ratio of unsaturated double bonds of the conjugated diene can be selected freely depending on the using purpose and is not particularly limited. In order to obtain a hydrogenated block copolymer having good heat stability and weather resistance, a hydrogenation ratio is recommended to 70% or greater, preferably 75% or greater, more preferably 85% or greater, especially preferably 90% or greater of the unsaturated double bonds of the conjugated diene compound in the hydrogenated block copolymer. In order to obtain a hydrogenated block copolymer having good heat stability, on the other hand, a hydrogenation ratio is preferably from 3 to 70%, more preferably from 5 to 65%, especially preferably from 10 to 60%. Although no particular limitation is imposed on the hydrogenation ratio of aromatic double bonds of the vinyl aromatic hydrocarbon in the hydrogenated block copolymer, it is preferred to adjust a hydrogenation ratio to not greater than 50%, preferably not greater than 30%, more preferably not greater than 20%. The hydrogenation ratio can be determined by a nuclear magnetic resonance apparatus (NMR).

In the present invention, a microstructure (cis, trans and vinyl contents) of the conjugated diene portion of the hydrogenated block copolymer can be changed freely by the use of the above-described polar compound or the like without particular limitation. In general, a vinyl bond content can be set within a range of from 5 to 90%, preferably from 10 to 80%, more preferably from 15 to 75%. The term “vinyl bond content” as used herein means a total content of 1,2-vinyl bonds and 3,4-vinyl bonds (provided that it is a 1,2-vinyl content when 1,3-butadiene is used as the conjugated diene). The vinyl bond content can be determined by a nuclear magnetic resonance apparatus (NMR).

### [Polymer (IV)]

In the present invention, there is also provided a composition containing Component (III) and at least one of the following (α) to (ε) as Polymer (IV):

(α) a block copolymer not containing Component (III) and composed of a vinyl aromatic hydrocarbon and a conjugated diene, or a hydrogenated product thereof,

(β) a polymer of a vinyl aromatic hydrocarbon,

(γ) a copolymer composed of a vinyl aromatic hydrocarbon and an aliphatic unsaturated carboxylic acid derivative, and

(ε) a rubber-modified styrene polymer.

The block copolymer composed of a vinyl aromatic hydrocarbon and a conjugated diene or the hydrogenated product thereof (α), different from the block copolymer or hydrogenated product thereof (III), (which may hereinafter be called Component (α)) to be used in the present invention has, as a polymer structure (polymer structure before hydrogenation in the case of the hydrogenated product), a mixture of radial block copolymers represented by the following formulas:

(Ab-Bb)ₙ, Ab-(Bb-Ab)ₙ, Bb-(Ab-Bb)ₙ₊₁, or a mixture of any of the polymer structures of block copolymers represented by the following formulas:

(Ab-Bb)ₖ]ₘ₊₁-X, [(Ab-Bb)ₖ-Ab]ₘ₊₁-X,

[(Bb-Ab)ₖ]ₘ₊₁-X, and [(Bb-Ab)ₖ-Bb]ₘ₊₁-X

(wherein, Ab is a polymer block composed mainly of a vinyl aromatic hydrocarbon; Bb is a polymer composed mainly of a conjugated diene; the boundaries between the block Ab and the block Bb are not necessarily clearly distinguished, X represents a residue of a coupling agent such as silicon tetrachloride, tin tetrachloride, 1,3-bis(N,N-glycidylaminomethyl)cyclohexane or epoxidized soybean oil, or a residue of an initiator such as polyfunctional organolithium compound; n stands for an integer of 1 or greater, typically from 1 to 5; and k and m stand for an integer from 1 to 5).

Component (α) has a number average molecular weight (molecular weight in terms of polystyrene) as measured by gel permeation chromatography (GPC) of from 30000 to 500000, preferably from 50000 to 500000, more preferably from 70000 to 300000. It may be a mixture of a plurality of block copolymers different in molecular weight. The block copolymer is recommended to have a melt flow index (measured in accordance with JISK-6870 under G conditions at a temperature of 200° C. and a load of 5 Kg) preferably from 0.1 to 100 g/10 min, from 0.5 to 50 g/10 min, more preferably from 1 to 30 g/10 min from the viewpoint of moldability or formability. The molecular weight and melt flow index can be controlled freely by the amount of a catalyst employed for the polymerization. Relative to the total amount of the vinyl aromatic hydrocarbon constituting Component (α), a content of the polymerized portion of a short-chain vinyl aromatic hydrocarbon having from 1 to 3 vinyl aromatic hydrocarbon units is recommended to be from 1 to 30 wt. %, preferably from 3 to 25 wt. %, more preferably from 5 to 20 wt. %. A proportion of the vinyl aromatic hydrocarbon blocks incorporated in Component (a) is from 50 to 95 wt. %, preferably from 55 to 90 wt. %, more preferably from 55 to 85 wt. %. The short-chain vinyl aromatic hydrocarbon content can be determined by subjecting the vinyl aromatic hydrocarbon component, which has been obtained by dissolving the block copolymer before hydrogenation in dichloromethane, carrying out oxidative decomposition of the resulting solution with ozone (O₃), reducing the resulting ozonide with lithium aluminum hydride in diethyl ether, and hydrolyzing the reduction product with pure water, to gel permeation chromatography (GPC) and calculating an area ratio the peaks thus obtained (refer to Takayuki Tanaka, Toshiya Sato and Yasunobu Nakafutami, Preprints of Meeting of the Society of Polymer Science, 29, 2051 (1980)).

The vinyl aromatic hydrocarbon polymer (β) (which may hereinafter be called “Component (β)”) to be used in the present invention is available by polymerizing a vinyl aromatic hydrocarbon or a monomer copolymerizable therewith (except (γ)). The vinyl aromatic hydrocarbon is mostly a styrene monomer, more specifically, a monomer selected from styrene, α-alkyl-substituted styrenes such as α-methylstyrene, nucleus alkyl-substituted styrenes and nucleus halogen-substituted styrenes. A proper one may be selected depending on the using purpose. Examples of the monomer copolymerizable with the vinyl aromatic hydrocarbon include acrylonitrile and maleic anhydride. Examples of the vinyl aromatic hydrocarbon polymer include polystyrene, styrene-α-methylstyrene copolymer, acrylonitrile-styrene copolymer, and styrene-maleic anhydride copolymer. Polystyrene is an especially preferred vinyl aromatic hydrocarbon polymer. These vinyl aromatic hydrocarbon polymers having a weight average molecular weight of typically from 50000 to 500000 are usable. These vinyl aromatic hydrocarbon polymers may be used either singly or as a mixture of two or more thereof and can be used as a rigidity improver.

The vinyl aromatic hydrocarbon of the copolymer composed of a vinyl aromatic hydrocarbon and an aliphatic unsaturated carboxylic acid derivative (γ) (which may hereinafter be called “Component (γ)”) to be used in the present invention means the above-described styrene monomer, while the aliphatic unsaturated carboxylic acid derivative means at least one derivative selected from acrylic acid, ester derivatives between a C₁₋₁₃, preferably C₂₋₁₃ alcohol and acrylic acid such as methyl acrylate, ethyl acrylate, propyl acrylate, butyl acrylate, pentyl acrylate and hexyl acrylate, methacrylic acid, ester derivatives between a C₁₋₁₃, preferably C₂₋₁₃, more preferably C₃₋₁₃ alcohol and methacrylic acid, α- or β-unsaturated dicarboxylic acids such as fumaric acid, itaconic acid and maleic acid, and mono- or di-ester derivatives between the dicarboxylic acid and a C₂₋₁₃ alcohol. They are typically composed mainly of the ester and its content is preferably 50 mole % or greater, more preferably 70 mole % or greater. The aliphatic unsaturated carboxylic acid derivative composed mainly of an ester, preferably ethyl acrylate, propyl acrylate, butyl acrylate, hexyl acrylate or octyl acrylate is preferred.

Component (γ) can be prepared by a known production process of a styrene resin, for example, bulk polymerization, solution polymerization, suspension polymerization, or emulsion polymerization. A polymer having a weight average molecular weight of typically from 50000 to 500000 is usable as Component (γ).

The copolymer composed of a vinyl aromatic hydrocarbon and an aliphatic unsaturated carboxylic acid derivative is especially preferably a copolymer composed mainly of styrene and n-butyl acrylate. A copolymer composed of an aliphatic unsaturated carboxylate and styrene and containing n-butyl acrylate and styrene in a total amount of 50 wt. % or greater, more preferably 60 wt. % or greater is still more preferred. A heat shrinkable film using the copolymer of aliphatic unsaturated carboxylate and styrene composed mainly of n-butyl acrylate and styrene has good shrink properties and good natural shrinkability.

The rubber modified styrene polymer (ε) (which may hereinafter be called Component (ε)) to be used in the present invention is available by polymerizing a mixture of a vinyl aromatic hydrocarbon or a monomer copolymerizable therewith and an elastomer copolymerizable therewith. The mixture is polymerized typically by suspension polymerization, emulsion polymerization, bulk polymerization, bulk-suspension polymerization or the like. Examples of the monomer copolymerizable with the vinyl aromatic hydrocarbon include α-methylstyrene, acrylonitrile, acrylates, methacrylates and maleic anhydride. As the elastomer copolymerizable with the vinyl aromatic hydrocarbon, natural rubber, synthetic isoprene rubber, butadiene rubber, styrene-butadiene rubber or high styrene rubber is used.

Usually a solution or latex obtained by adding from 3 to 50 parts by weight of the elastomer to 100 parts by weight of the vinyl aromatic hydrocarbon or monomer copolymerizable therewith is provided for emulsion polymerization, bulk polymerization, bulk-suspension polymerization or the like. Particularly preferred rubber-modified styrene polymer is an impact-resistant rubber-modified styrene polymer (HIPS). The rubber-modified styrene polymer can be utilized as an improver for rigidity, impact resistance and slip properties. Rubber-modified styrene polymers having a weight average molecular weight of typically from 50000 to 500000 are usable. The rubber modified styrene polymer is added preferably in an amount of from 0.1 to 10 parts by weight to 100 parts by weight of Component (III) in order to maintain transparency.

Components (α) to (ε) to be used in the present invention are recommended to have MFR (under G condition, temperature: 200° C., load: 5 kg) of from 0.1 to 100 g/10 min, preferably from 0.5 to 50 g/10 min, especially preferably from 1 to 30 g/10 min, from the viewpoint of moldability or formability.

### [Composition 8]

A composition of the present invention containing Components (III) and (IV) (which may hereinafter be called “Composition B of the present invention”) contains Component (III) and Component (IV) at a weight ratio of from 1/99 to 99/1, preferably from 5/95 to 95/5, more preferably from 10/90 to 90/10. The balance between rigidity and elongation is excellent at a Component (III)/Component (IV) weight ratio falling within a range of from 1/99 to 99/1.

In Composition B of the present invention, a ratio (E′40/E′20) of a storage elastic modulus at 40° C. (E′40) to a storage elastic modulus at 20° C. (E′20) is from 0.75 to 1 and the peak temperature of function tan δ of dynamic viscoelasticity measurement is within a range of from 70 to 125° C.; preferably a ratio (E′40/E′20) of a storage elastic modulus at 40° C. (E′40) to a storage elastic modulus at 20° C. (E′20) is from 0.80 to 1 and the peak temperature of function tan δ of dynamic viscoelasticity measurement is within a range of from 75 to 120° C.; more preferably a ratio (E′40/E′20) of a storage elastic modulus at 40° C. (E′40) to a storage elastic modulus at 20° C. (E′20) is from 0.85 to 1 and the peak temperature of function tan δ of dynamic viscoelasticity measurement is within a range of from 80 to 115° C. When the ratio (E′40/E′20) of a storage elastic modulus at 40° C. (E′40) to a storage elastic modulus at 20° C. (E′20) falls within a range of from 0.75 to 1 and the peak temperature of function tan δ of dynamic viscoelasticity measurement falls within a range of from 75 to 125° C., Composition B can provide a film excellent in rigidity and heat shrink properties.

Addition, to 100 parts by weight of Composition B, of from 0.01 to 5 parts by weight, preferably from 0.05 to 4 parts by weight, more preferably from 0.1 to 3 parts by weight of at least one lubricant selected from fatty acid amides, paraffins, hydrocarbon resins and fatty acids enables improvement of blocking resistance.

Examples of the fatty acid amide include stearamide, oleylamide, erucylamide, behenamide, a mono- or bisamide of a higher fatty acid, ethylenebisstearamide, stearyloteylamide, and N-stearylerucamide. They may be used either singly or as a mixture of two or more thereof. Examples of the paraffin and hydrocarbon resin include paraffin wax, microcrystalline wax, liquid paraffin, paraffin synthetic wax, polyethylene wax, composite wax, montan wax, hydrocarbon wax, and silicone oil. They may be used either singly or as a mixture of two or more thereof.

Examples of the fatty acid include saturated fatty acids and unsaturated fatty acids, more specifically, saturated fatty acids such as lauric acid, palmitic acid, stearic acid, behenic acid, and hydroxystearic acid and unsaturated fatty acids such as oleic acid, erucic acid, and ricinolic acid. These may be used either singly or as a mixture of two or more thereof.

Addition of from 0.05 to 3 parts by weight, preferably from 0.05 to 2.5 parts by weight, more preferably from 0.1 to 2 parts by weight of at least one ultraviolet absorber and light stabilizer selected from benzophenone ultraviolet absorbers, benzotriazole ultraviolet absorbers and hindered amine light stabilizers, to 100 parts by weight of Composition B enables improvement of light resistance.

Examples of the benzophenone ultraviolet absorbers include 2,4-dihydroxybenzophenone, 2-hydroxy-4-methoxybenzophenone, 2,2′-dihydroxy-4-methoxybenzophenone, 2,2′-dihydroxy-4,4′-dimethoxybenzophenone, 2-hydroxy-4-n-octoxybenzophenone, 2,2′4′4-tetrahydroxybenzophenone, 4-dodecyloxy-2-hydroxybenzophenone, 3,5-di-t-butyl-4-hydroxybenzoylic acid, n-hexadecyl ester, bis(5-benzoyl-4-hydroxy-2-methoxyphenyl)methane, 1,4-bis(4-benzoyl-3-hydroxyphenoxy)butane, and 1,6-bis(4-benzoyl-3-hydroxyphenoxy)hexane.

Examples of the benzotriazole ultraviolet absorbers include 2-(2′-hydroxy-5′-methyl-phenyl)benzotriazole, 2-(2′-hydroxy-3′,5′-di-t-butyl-phenyl)benzotriazole, 2-(2′-hydroxy-3′-t-butyl-5′-methyl-phenyl)-5-chlorobenzotriazole, 2-(2′-hydroxy-3′,5′-di-t-butyl-phenyl)-5-chlorobenzotriazole, 2-(2′-hydroxy-5′-t-octylphenyl)benzotriazole, 2-(2′-hydroxy-3′,5′-di-amylphenyl)benzotriazole, 2-[2′-hydroxy-3′-(3′,4′,5′,6′-tetrahydrophthalimidomethyl)-5′-methylphenyl]benzotriazole, 2-2′-methylenebis[4-(1,1,3,3-tetramethylbutyl)-6-(2H-benzotriazol-2-yl)phenol], 2-[2-hydroxy-3,5-bis(α,α-dimethylbenzyl)phenyl]-2H-benzotriazole, 2-(2-hydroxy-4-octyloxyphenyl)-2H-benzotriazole, 2-(2H-benzotriazol-2-yl)-4-methyl-6-(3,4,5,6-tetrahydrophthalimidylmethyl)phenol.

Examples of the hindered amine light stabilizers include bis(2,2,6,6-tetramethyl-4-piperidyl)sebacate, bis-(1,2,6,6,6,-penmethyl-4-piperidyl)sebacate, 1-[2-(3-(3,5-di-tertiary butyl-4-hydroxyphenyl)propionyloxy)-ethyl]-4-(3-(3,5-di-tertiary butyl-4-hydroxyphenyl)propionyloxy)-2,2,6,6-tetramethylpiperidine, 8-acetyl-3-dodecyl-7,7,9,9-tetramethyl-1,3,8-triazaspiro[4,5]decane-2,4-dione, 4-benzoyloxy-2,2,6,6-tetramethylpiperidine, and (dimethyl succinate)-1-(2-hydroxyethyl)-4-hydroxy-2,2,6,6-tetramethylpiperidine polycondensate.

Additional examples include poly[[6-1,3,3-tetramethylbutyl)imino-1,3,5-triazine-2,4-diyl][(2,2,6,6-tetramethyl-4-piperidyl)imino]hexamethylene[[2,2,6,6-tetramethyl-4-piperidyl]imino]], poly[6-morpholino-s-triazine-2,4-diyl][(2,2,6,6-tetramethyl-4-piperidyl)imino]-hexamethylene[2,2,6,6-tetramethyl-4-piperidyl)imino]], 2-(3,5-di-tertiary butyl-4-hydroxybenzyl)-2-n-(butylmalonic acid)bis(1,2,2,6,6-pentamethyl-4-piperidyl), tetraxy(2,2,6,6-tetramethyl-4-piperidyl)1,2,3,4-butane tetracarboxylate, tetraxy(1,2,2,6,6-pentamethyl-4-piperidyl)1,2,3,4-butane tetracarboxylate and condensate of 1,2,3,4-butanetetracarboxylic acid, 1,2,2,6,6-pentamethyl-4-piperidinol and tridecyl alcohol.

Further additional examples include condensate of 1,2,3,4-butanetetracarboxylic acid, 2,2,6,6-tetramethyl-4-piperidinol and tridecyl alcohol, condensate of 1,2,3,4-butanetetracarboxylic acid, 1,2,2,6,6-pentamethyl-4-piperidinol and β,β,β,β-tetramethyl-3,9-(2,4,8,10-tetraoxaspiro[5,5]undecane)diethanol, condensate of 1,2,3,4-butanetetracarboxylic acid, 2,2,6,6-tetramethyl-4-piperidinol and β,β,β,β-tetramethyl-3,9-(2,4,8,10-tetraoxaspiro[5,5]undecane)diethanol, condensate of N,N′-bis(3-aminopropyl)ethylenediamine and 2,4-bis[N-butyl-N-(1,2,2,6,6-pentamethyl-4-piperidyl)amino]-6-chloro-1,3,5-triazine, polycondensate of dibutylamine, 1,3,5-triazine, N,N-bis(2,2,6,6-tetramethyl-4-piperidyl-1,6-hexamethylenediamine and N-2,2,6,6-tetramethy-4-piperidyl)butylamine, 1,2,2,6,6-tetramethyl-4-piperidyl methacrylate, and 2,2,6,6-tetramethyl-4-piperidyl methacrylate.

Addition of from 0.05 to 3 parts by weight, more preferably from 0.1 to 2 parts by weight of 2-[1-(2-hydroxy-3,5-di-t-pentylphenyl)ethyl]-4,6-di-t-pentylphenyl acrylate as a stabilizer to 100 parts by weight of Composition B of the present invention is effective for suppressing gelation. Addition of the stabilizer in an amount less than 0.05 parts by weight is not effective for suppressing gelation, while addition of it in an amount exceeding 3 parts by weight does not bring about a gelation suppressing effect higher than that of the present invention,

It is possible to add to Composition B of the present invention from 0.05 to 3 parts by weight, based on 100 parts by weight in total of Components (III) and (IV), of at least one phenolic stabilizer such as n-octadecyl-3-(3,5-di-t-butyl-4-hydroxyphenyl)propionate, 2-t-butyl-6-(3-t-butyl-2-hydroxy-5-methylbenzyl)-4-methylphenyl acrylate, 2,4-bis[(octylthio)methyl]-o-cresol, tetrakis[methylene-3-(3,5-i-t-butyl-4-hydroxyphenyl)propionate]methane, 1,3,5-trimethyl-2,4,6-tris(3,5-di-t-butyl-4-hydroxybenzyl)benzene or 2,4-bis-(n-octylthio)-6-(4-hydroxy-3,5-di-t-butylanilino)-1,3,5-triazine and from 0.05 to 3 parts by weight, based on 100 parts by weight of Composition B, of at least one organic phosphate or organic phosphite stabilizer such as tris-(nonylphenyl)phosphite, 2,2-methylenebis(4,6-di-t-butylphenyl)octylphosphite, 2-[[2,4,8,10-tetrakis(1,1-dimethylethyl)dibenzo[d,f][1,3,2]dioxaphosphepin-6-yl]oxy]-N, N-bis[2-[[2,4,8,10-tetrakis(1,1-dimethylethyl)dibenzo[d,f][1,3,2]dioxaphosphepin-6-yl]oxy]ethyl]etheneamine or tris(2,4-di-t-butylphenyl)phosphite.

Various polymers and additives can be added to Composition B of the present invention, depending on the using purpose.

Composition B of the present invention may contain a block copolymer composed of a vinyl aromatic hydrocarbon and a conjugated diene which are different from those of Components (III) and (IV) of the present invention, and/or a hydrogenated product of the block copolymer; having a vinyl aromatic hydrocarbon content of from 60 to 95 wt. %, preferably from 65 to 90 wt. %; and having a similar structure to that of Component (III) of the present invention. Addition of, based on 100 parts by weight of Component (III) of the present invention, from 5 to 90 parts by weight, preferably from 10 to 80 parts by weight of it enables improvement of impact resistance and rigidity.

Preferred examples of another additive include softening agents and plasticizers such as coumarone-indene resins, terpene resins and oils. Further, various stabilizers, pigments, antiblocking agents, antistatic agents, lubricants and the like can also be added. Examples of the antiblocking agent, antistatic agent and lubricant include fatty acid amides, ethylenebis stearamide, sorbitan monostearate, saturated fatty acid esters of a fatty acid alcohol, and pentaerythritol fatty acid esters, while those of the ultraviolet absorber include compounds described in Practical Handbook of Additives for Plastics and Rubbers (Kagaku Kogyosha) such as p-t-butylphenyl salicylate, 2-(2′-hydroxy-5′-methylphenyl)benzotriazole, 2-(2′-hydroxy-3′-t-butyl-5′-methylphenyl)-5-chlorobenzotriazole and 2,5-bis-[5′-t-butylbenzoxazolyl-(2)]thiophene. The above-described additive may be added typically in an amount ranging from 0.01 to 5 wt. %, preferably from 0.05 to 3 wt. %.

Composition B of the invention can be produced by any conventionally known mixing method. Examples include a melting and kneading method using a typical mixer such as open roll, intensive mixer, internal mixer, cokneader, continuous kneader equipped with a twin rotor or extruder and a method of dissolving or dispersing each component in a solvent and mixing the resulting solution or dispersion, and then removing the solvent by heating.

The block copolymer or hydrogenated product thereof (III) and Composition B of the present invention can be used as any layer of an unstretched or stretched molding or forming sheet obtained by extrusion, stretched film (heat shrinkable film or lamination film), or at least one layer of a multilayer molding or forming sheet. It can also be used in injection molding. It is particularly suited for sheet or film uniaxially or biaxially stretched by extrusion.

### [Heat Shrinkable Film]

A heat shrinkable film can be obtained from the block copolymer or hydrogenated product thereof (III) or Composition B of the present invention preferably by a production process comprising a first inflation step of forming a tube having a thickness of from 0.05 to 0.5 mm and a second inflation step, successively to the first inflation step, of stretching the tube to from 1.5 to 5 times the original length in TD in a hot water of from 65 to 100° C. A process of extruding the materials from a typical T die or annular dice into a flat or tube shape at from 150 to 250° C., preferably from 170 to 220° C. and then, substantially uniaxially or biaxially stretching the resulting unstretched product may also be used. When a heat shrinkable film is a uniaxially stretched film, the film or sheet is obtained by stretching in MD by a calender roll or the like or in a direction perpendicular to MD by a tenter or the like. When a heat shrinkable film is a biaxially stretched film, an extruded film or sheet is stretched in the machine direction by means of a metal roll or the like and then stretched in the transverse direction by a tenter or the like, while a tube is obtained by stretching simultaneously or separately in a circumferential direction of the tube or a direction perpendicular to the axis of the tube.

For obtaining a heat shrinkable film using a flat sheet or tube-like sheet extruded through an ordinarily employed T die or annular dice, the stretching temperature is set at from 85 to 130° C., preferably from 90 to 120° C. and stretching is preferably performed at a draw ratio of from 1.5 to 8, preferably from 2 to 6 in the machine direction and/or transverse direction.

When the heat shrinkable film of the present invention obtained by uniaxial or biaxial stretching is used as a heat shrinkable packaging material, heat shrinkage may be caused by heating at from 130 to 300° C., preferably from 150 to 250° C. for from several seconds to several minutes, preferably from 1 second to 60 seconds in order to accomplish a desired heat shrinkage ratio.

The heat shrinkable film of the present invention may be a multilayer laminate having a structure of at least two layers, preferably at least three layers. Specific examples of the usage as the multilayer laminate include those disclosed, for example, Japanese Patent Publication No. Hei 3-5306. The heat shrinkable film of the present invention may be used for an intermediate layer and both outer layers. When the heat shrinkable film of the present invention is used as an intermediate layer, the outer layer film has desirably a Vicat softening point higher by 3 to 15° C., preferably by 5 to 12° C. than that of the intermediate layer. A multilayer film with an outer layer film having a Vicat softening point higher by 3 to 15° C. than that of the intermediate layer is excellent in the balance of natural shrinkage properties and low-temperature shrinkage properties.

When the heat shrinkable film of the present invention is used as a multilayer film, no particular limitation is imposed on a layer other than the layer of the heat shrinkable film of the present invention. It may be a multilayer laminate using, in combination, a block copolymer and/or hydrogenated product thereof other than those used in the present invention or a composition composed of a block copolymer and/or hydrogenated product thereof other than those used in the present invention and the above-described vinyl aromatic hydrocarbon polymer. Also usable is at least one component selected from polypropylene, polyethylene, ethylene polymer (copolymer of ethylene and vinyl acetate, copolymer of ethylene and ethyl acrylate, copolymer of ethylene and acrylic acid, or the like), ionomer resin, nylon resin, polyester resin, poly(methyl methacrylate) resin, ABS resin and the above-described vinyl aromatic hydrocarbon polymer. Preferred are the block copolymer and/or hydrogenated product thereof other than those used in the present invention, composition having the block copolymer and/or hydrogenated product thereof other than those used in the present invention and the vinyl aromatic hydrocarbon polymer, and the above-described vinyl aromatic hydrocarbon polymer.

The thickness of the heat shrinkable film and heat shrinkable multilayer film of the present invention is from 10 to 300 μm, preferably from 20 to 200 μm, more preferably from 30 to 100 μm. A thickness ratio of the surface layers on both sides of the multilayer film to the inner layer is recommended to be from 5/95 to 45/55, preferably from 10/90 to 35/65.

The heat shrinkable film of the present invention can be used for various applications, for example, packages of fresh food and confectionery and packages of clothes, stationery and the like. It is particularly preferred when employed as a material for so-called heat shrinkable labels to be used by adhering a uniaxially stretched film made of the block copolymer specified in the present invention on which letters or designs have been printed to a surface of an article to be packaged such as plastic molding, metal product, glass vessel or porcelain, while applying heat to cause heat shrinkage.

In particular, the uniaxially-stretched heat shrinkable film of the present invention is excellent in low temperature shrinkability, rigidity and natural shrinkability so that it can be suitably utilized as, as well as a material for heat shrinkable labels for plastic moldings which undergo deformation when heated to high temperatures, a material for heat shrinkable labels for vessels made of at least one material selected from metals, porcelain, glass, paper, polyolefin resins such as polyethylene, polypropylene and polybutene, polymethacrylate resins, polycarbonate resins, polyester resins such as polyethylene terephthalate and polybutylene terephthalate and polyamide resins that are extremely different from the block copolymer of the present invention in a coefficient of thermal expansion, water absorption properties or the like.

Examples of the material constituting plastic vessels for which the heat shrinkable film of the present invention can be used include, as well as the above-described resins, polystyrene, rubber-modified high-impact polystyrene (HIPS), styrene-butyl acrylate copolymers, styrene-acrylonitrile copolymers, styrene-maleic anhydride copolymers, acrylonitrile-butadiene-styrene copolymers (ABS), methacrylate-butadiene-styrene copolymers (MBS), polyvinyl chloride resins, polyvinyl chloride resins, phenol resins, urea resins, melamine resins, epoxy resins, unsaturated polyester resins and silicone resins. These plastic vessels may each be made of either a mixture of two or more of the resins or a laminate thereof.

### EXAMPLES

The present invention will hereinafter be described in further detail by Examples. It should however be borne in mind that the present invention is not limited by them.

In Examples, block copolymers or hydrogenated products thereof shown in Table 1 were prepared as A-1 to A-7 and they were used as Component (I) or Component (i) in Table 3. Styrene and n-butyl acrylate copolymers B-1 and B-2 in Table 2 were prepared and they were used as Component (ii) in Table 3. As Components (iii) and (iv) in Table 3, commercially available “PSJ Polystyrene 685” and “PSJ Polystyrene 475D” in Table 2 were used, respectively.

Block copolymers or hydrogenated products thereof were prepared as C-1 to C-9 as shown in Table 4 and they were used as Component (III) or Component (a) in Tables 6 and 7. Styrene-n-butyl acrylate copolymers D-1 and D-2 in Table 5 were prepared and they were used as Component (γ) in Tables 6 and 7. As Components (β) and (ε) in Tables 6 and 7, commercially available “PSJ Polystyrene 685” and “PSJ Polystyrene 475D” in Table 5, were used, respectively.

TABLE 1

| | | Butadiene/ | Number | | | | Hydrogen- |
|---|---|---|---|---|---|---|---|
| | Styrene | isoprene | average | Peak | E′ | | ation |
| | content | (weight | molecular | molecular | (50° C.) | MFR | ratio |
| | (wt. %) | ratio) | weight | weight | (Pa) | (g/10 min) | (wt. %) |
| A-1 | 92 | 88/12 | 122000 | \textcircled{1}141000 | 2.41 × 10⁹ | 5 | 0 |
| | | | | \textcircled{2}520000 | | | |
| A-2 | 90 | 100/0 | 172000 | \textcircled{1}150000 | 2.38 × 10⁹ | 3 | 97 |
| | | | | \textcircled{2}610000 | | | |
| A-3 | 72 | 100/0 | 109000 | \textcircled{1}131000 | 0.88 × 10⁹ | 8 | 0 |
| A-4 | 97 | 50/50 | 187000 | \textcircled{1}193000 | 2.53 × 10⁹ | 4 | 0 |
| A-5 | 40 | 100/0 | 48000 | \textcircled{1}56000 | 0.15 × 10⁹ | 10 | 0 |
| A-6 | 32 | 90/10 | 38000 | \textcircled{1}47000 | 0.06 × 10⁹ | 8 | 25 |
| A-7 | 58 | 100/0 | 88000 | \textcircled{1}91000 | 0.65 × 10⁹ | 5 | 0 |

TABLE 2

| | Styrene content (wt. %) |
|---|---|
| B-1 | 79 |
| B-2 | 88 |
| B-3 | GPPS |
| B-4 | HIPS |

B-1 and B-2: Styrene-n-butyl acrylate copolymer
B-3: “PSJ Polystyrene 685” (product of PS Japan Corporation)
B-4: “PSJ Polystyrene 475D”(product of PS Japan Corporation)

TABLE 3

| | | | Ex. 1 | Ex. 2 | Ex. 3 | Ex. 4 | Ex. 5 |
|---|---|---|---|---|---|---|---|
| Formulation | Component | Kind and amount of | A-1/A-3 | A-2/A-3 | A-1/A-3 | A-2/A-3 | A-1/A-3 |
| and | (I) | Component (I) (wt. %) | 46/36 | 30/30 | 40/20 | 47/30 | 53/28 |
| analysis | Component | Kind and amount of | A-6 | A-5 | A-5 | A-5 | A-5 |
| | (II) | Component (i) (wt. %) | 11 | 9 | 15 | 4 | 9 |
| | | Kind and amount of | B-2 | B-1 | B-2 | B-1 | B-2 |
| | | Component (ii) (wt. %) | 5 | 28 | 23 | 16 | 8 |
| | | Kind of Component | B-4 | B-3/B-4 | B-4 | B-4 | B-4 |
| | | (iii, iv) (wt. %) | 2 | 1/2 | 2 | 3 | 2 |

| | | | | | | |
|---|---|---|---|---|---|---|
| | Styrene content (wt %) | 78 | 77 | 79 | 81 | 81 |
| | Storage elastic modulus at 50° C. (Pa) | 1.21 × 10⁹ | 1.17 × 10⁹ | 1.18 × 10⁹ | 1.21 × 10⁹ | 1.24 × 10⁹ |
| | A ratio of molecular weight of | 25 | 17 | 22 | 25 | 30 |
| | 200000 or greater (wt. %) | | | | | |
| Physical | Modulus in tension (Kg/cm2) | 15800 | 15400 | 16100 | 16400 | 16700 |
| properties | Elongation (%) | 410 | 420 | 380 | 350 | 280 |
| of film | | | | | | |
| | Haze (%) | 0.7 | 0.8 | 0.6 | 1 | 0.7 |
| | 90° C. Shrinkage (%) MD | 7 | 8 | 8 | 6 | 7 |
| | TD | 38 | 39 | 39 | 34 | 38 |
| | Stability in extrusion molding film | A | A | A | A | A |

| | | | | | Comp. | Comp. |
|---|---|---|---|---|---|---|
| | | | Ex. 6 | Ex. 7 | Ex. A-4 | Ex. 2 |
| Formulation | Component | Kind and amount of | A-1/A-3 | A-2/A-3 | A-4 | A-7 |
| and | (I) | Component (I) (wt. %) | 60/40 | 40/60 | 73 | 50 |
| analysis | Component | Kind and amount of | — | — | A-6 | A-5 |
| | (II) | Component (i) (wt. %) | — | — | 10 | 15 |
| | | Kind and amount of | — | — | B-1 | B-2 |
| | | Component (ii) (wt. %) | — | — | 15 | 30 |
| | | Kind of Component | — | — | B-4 | B-4 |
| | | (iii, iv) (wt. %) | — | — | 2 | 5 |

| | | | | | |
|---|---|---|---|---|---|
| | Styrene content (wt %) | 84 | 79 | 88 | 66 |
| | Storage elastic modulus at 50° C. (Pa) | 1.33 × 10⁹ | 1.16 × 10⁹ | 1.50 × 10⁹ | 0.62 × 10⁹ |
| | A ratio of molecular weight of | 32 | 31 | 8 | 6 |
| | 200000 or greater (wt. %) | | | | |
| Physical | Modulus in tension (Kg/cm2) | 17100 | 15300 | Film | 8200 |
| properties | Elongation (%) | 250 | 470 | was not | 500 or |
| of film | | | | formed. | greater |
| | Haze (%) | 0.7 | 0.7 | | 2.5 |
| | 90° C. Shrinkage (%) MD | 8 | 8 | | 17 |
| | TD | 40 | 35 | | 35 |
| | Stability in extrusion molding film | A | A | B | B |

TABLE 4

| | | Butadiene/ | Number | | | Component a/ | | E″ | Hydrogen- |
|---|---|---|---|---|---|---|---|---|---|
| | Styrene | Isoprene | average | | Peak | Component b | E′ | peak | ation |
| | content | (weight | molecular | MFR | molecular | (weight | (30° C.) | temperature | ratio |
| | (wt %) | ratio) | weight | (g/10 min) | weight | ratio) | (Pa) | (° C.) | (wt. %) |
| C-1 | 92 | 88/12 | 122000 | 5 | (1) 141000 | 68/32 | 2.41 × 10⁹ | 90 | 0 |
| | | | | | (2) 520000 | | | | |
| C-2 | 90 | 100/0 | 172000 | 3 | (1) 150000 | 57/43 | 2.38 × 10⁹ | 84 | 97 |
| | | | | | (2) 610000 | | | | |
| C-3 | 82 | 100/0 | 108000 | 3 | (1) 121000 | 78/22 | 0.95 × 10⁹ | 104 | 0 |
| | | | | | (2) 475000 | | | | |
| C-4 | 75 | 100/0 | 96000 | 3 | (1) 104000 | 81/19 | 0.73 × 10⁹ | 103 | 0 |
| | | | | | (2) 420000 | | | | |
| C-5 | 97 | 50/50 | 187000 | 4 | (1) 193000 | 100/0 | 2.53 × 10⁹ | 113 | 0 |
| C-6 | 40 | 100/0 | 48000 | 10 | (1) 56000 | 100/0 | 0.25 × 10⁹ | 94 | 0 |
| C-7 | 32 | 90/10 | 38000 | 8 | (1) 47000 | 100/0 | 0.18 × 10⁹ | 92 | 25 |
| C-8 | 58 | 100/0 | 88000 | 5 | (1) 91000 | 100/0 | 0.72 × 10⁹ | 107 | 0 |
| C-9 | 92 | 88/12 | 118000 | 13 | (1) 141000 | 100/0 | 2.38 × 10⁹ | 90 | 0 |

TABLE 5

| | Styrene content (wt. %) |
|---|---|
| D-1 | 79 |
| D-2 | 88 |
| D-3 | GPPS |
| D-4 | HIPS |

D-1 and D-2: Styrene-n-butyl acrylate copolymer
D-3: “PSJ Polystyrene 685” (product of PS Japan Corporation)
D-4: “PSJ Polystyrene 475D” (product of PS Japan Corporation)

TABLE 6

| | | | | | | | | Comp. | Comp. |
|---|---|---|---|---|---|---|---|---|---|
| | | | Ex. 8 | Ex. 9 | Ex. 10 | Ex. 11 | Ex. 12 | Ex. 1 | Ex. 2 |
| Formulation | Component | Kind and amount of | C-1/C-4 | C-2/C-4 | C-1/C-4 | C-2/C-3 | C-2/C-4 | C-5 | C-8 |
| and | (III) | Component (III) (wt %) | 45/35 | 30/30 | 35/25 | 52/25 | 55/45 | 73 | 50 |
| analysis | Component | Kind and amount of | C-7 | C-6 | C-6 | C-6 | — | C-7 | C-6 |
| | (IV) | Component (α) (wt %) | 11 | 9 | 15 | 12 | — | 10 | 15 |
| | | Kind and amount of | D-2 | D-1 | D-2 | D-1 | — | D-1 | D-2 |
| | | Component (γ) (wt. %) | 7 | 28 | 23 | 8 | — | 15 | 30 |
| | | Kind and amount of | D-4 | D-4/D-4 | D-4 | D-4 | — | D-4 | D-4 |
| | | Component (β, ε) (wt. %) | 2 | 1/2 | 2 | 3 | — | 2 | 5 |
| | E′40/E′20 | | 0.87 | 0.89 | 0.85 | 0.83 | 0.91 | 0.98 | 0.72 |
| | Tan δ peak temperature (° C.) | | 111 | 109 | 113 | 107 | 110 | 128 | 114 |
| Physical | Modulus in tension (Kg/cm2) | | 16000 | 15700 | 15900 | 15500 | 16900 | Film | 8200 |
| properties | Elongation (%) | | 390 | 400 | 410 | 420 | 280 | was not | 500 or |
| of film | | | | | | | | formed. | greater |
| | Haze (%) | | 0.8 | 0.8 | 0.6 | 1 | 0.6 | | 2.5 |
| | 90° C. | MD | 8 | 9 | 7 | 10 | 8 | | 17 |
| | Shrinkage (%) | TD | 39 | 40 | 37 | 42 | 40 | | 35 |

| | | | | | | | |
|---|---|---|---|---|---|---|---|
| Stability in extrusion molding film | A | A | A | A | A | B | B |

TABLE 7

| | | | | | | Comp. |
|---|---|---|---|---|---|---|
| | | | Ex. 13 | Ex. 14 | Ex. 15 | Ex. 5 |
| Formulation | Component | Kind and amount of | C-1/C-4 | C-2/C-3 | C-2/C-4 | C-9/C-8 |
| and | (III) | Component (III) (wt. %) | 50/40 | 45/30 | 45/35 | 60/30 |
| Analysis | Component | Kind and amount of | C-6 | C-7/C-8 | C-7 | C-6 |
| | (IV) | Comp. (α) (wt. %) | 8 | 10/10 | 10 | 8 |
| | | Kind and amount of | — | D-1 | D-2 | — |
| | | Component (γ) (wt. %) | — | 3 | 8 | — |
| | | Kind and amount of | D-4 | D-4 | D-3/D-4 | D-4 |
| | | Component (β, ε) (wt. %) | 2 | 2 | 1/1 | 2 |

| | | | | | |
|---|---|---|---|---|---|
| | E′40/E′20 | 0.91 | 0.88 | 0.9 | 0.93 |
| | Tan δ peak temperature (° C.) | 109 | 111 | 106 | 1.04 |
| Physical | Modulus in tension (Kg/cm2) | 16800 | 16300 | 16500 | 16800 |
| properties | −10° C. Elongation (%) | 320 | 280 | 300 | 160 |
| of film | Haze (%) | 0.9 | 1 | 0.9 | 1.7 |
| | 80° C. Shrinkage (%) | 37 | 34 | 41 | 43 |
| | Natural shrinkage (%) | 1.7 | 1.5 | 1.8 | 1.6 |

Structural characteristics and physical properties shown in Tables 1 to 7 were measured in the following manners.

(1) Number average molecular weight: The molecular weight of a hydrogenated block copolymer was measured using a GPC apparatus (product of TOSOH/Japan). Measurement was conducted at 35° C. while using tetrahydrofuran as a solvent. By using a calibration curve drawn using a commercially available standard polystyrene whose weight-average molecular weight and number-average molecular weight were known, the number average molecular weight was determined.

(2) Dynamic viscoelasticity: The E′ (30° C.), E′ (50° C.), E″ peak temperature and E′40/E′20 of a 1-mm thick test piece, which had been obtained by compression molding of pellets by a hot press, were determined using a viscoelasticity analyzer, “DVE-V4”, manufactured by UBM at an oscillation frequency of 35 Hz at a temperature elevation rate of 3° C./min at a temperature ranging from −50° C. to 150° C.

(3) Hydrogenation ratio: The hydrogenation ratio of the hydrogenated block copolymer was measured using a nuclear magnetic resonance apparatus (apparatus name: “DPX-400”, made by BRUKER/Germany).

(4) A ratio of molecular weight of 200000 or greater A total area of a molecular weight distribution curve was found from the chromatochart obtained above in (1) and an area of molecular weight of 200000 or greater was divided by the total area of the molecular weight distribution curve. The value thus obtained was expressed by percentage.

(5) Peak molecular weight: A molecular weight corresponding to the peak top in the chromatochart obtained above in (1) was found from the calibration curve.

(6) Component (a)/Component (b): Areas corresponding to Component (a) and Component (b) were found from the chromatochart obtained above in (1) and their area ratio was designated as Component (a)/Component (b) (a weight ratio supposing that the total of Components (a)+Component (b) is 100).

(7) Haze (indicator of transparency): Haze was measured in accordance with ASTM D1003A (by applying liquid paraffin to a 0.05 mm-thick heat shrinkable film used as a test piece). The lower the haze, the better transparency.

(8) Heat shrinkage: A stretched film was dipped in hot water of 95° C. for 5 seconds and a heat shrinkage ratio was calculated using the following equation:

Heat shrinkage (%)=(L1−L2)/L1×100

(wherein, L1 represents a length before shrinkage (direction of orientation) and L2 represents a length after shrinkage (direction of orientation).

(9) Modulus in tension (indicator of rigidity), elongation and −10° C. elongation: A modulus in tension, elongation and −10° C. elongation were measured in accordance with JIS K 6732 in the film orientation direction at a pulling rate of 5 mm/min. A test piece having a width of 12.7 mm and having a gage distance of 50 mm was employed. The modulus in tension was measured at 23° C., while the elongation was measured at each of 23° C. and −10° C.

(10) Stability in extrusion molding film: The thickness of the heat shrinkable film was measured using a dial gage at totally 20 points or greater spaced equally, more specifically, at least 10 points in the transverse direction (TD) of the film and at least 10 points in the machine direction (MD) and an average of them was calculated. A half of the difference between the maximum thickness and minimum thickness relative to the average was then indicated by a percentage while attaching thereto with a sign of ±.

A: A difference in film thickness is within ±15%.

B: A difference in film thickness exceeds ±15% but not greater than ±20%.

C: A difference in film thickness exceeds ±20% or an expanded film is broken.

11) 80° C. Shrinkage

A stretched film was dipped in hot water of 80° C. for 10 seconds and a shrinkage ratio was calculated using the following equation:

80° C. Heat shrinkage (%)=(L−L1)/L×100

(wherein, L: a length before shrinkage and L1: a length after shrinkage).

12) Natural Shrinkage

A stretched film was left to stand at 35° C. for 3 days and a natural shrinkage ratio was calculated using the following equation:

Natural shrinkage (%)=(L2−L3)L2×100

(wherein L1: a length before the film was left alone and L3: a length after the film was left alone). The smaller a natural shrinkage ratio, the better natural shrinkability.

Preparation processes of A-1 to A-7 constituting Component (I) and Component (i) and C-1 to C-9 constituting Component (III) and Component (α) will hereinafter be described.

Block copolymers having structural characteristics as shown in Table 1 were prepared by polymerizing styrene and butadiene in cyclohexane while using n-butyllithium as an initiator and tetramethylethylenediamine as a randomizing agent. The styrene content was controlled by the addition amounts of styrene and butadiene, the number average molecular weight and MFR were controlled by the amount of the catalyst, and the peak molecular weight was controlled by the amounts of the catalyst and coupling agent. In the preparation of the block copolymers, a monomer diluted with cyclohexane to a concentration of 25 wt. % was employed.

As a hydrogenation catalyst used for the preparation of hydrogenated block copolymers, that obtained by charging 1 L of dried and purified cyclohexane in a reaction vessel purged with nitrogen, adding 100 mmol of bis(η5-cyclopentadienyl)titanium dichloride, adding an n-hexane solution containing 200 mmol of trimethylaluminum while stirring sufficiently, and reacting the resulting mixture at room temperature for about 3 days.

For example, block copolymers A-1 (similar to C-1), A-2 (similar to C-2), C-3, C-4 and C-9 were prepared by the following processes, respectively.

### <Preparation Process of A-1 (C−1)>

In an autoclave equipped with a stirrer, polymerization was performed at 70° C. for 15 minutes by adding all of a cyclohexane solution containing 10 wt. % of styrene, 0.06 part by weight of n-butyllithium, and 0.2 mole, per mole of n-butyllithium, of tetramethylethylenediamine, in one minute in a nitrogen gas atmosphere. Polymerization was then performed at 70° C. by adding a cyclohexane solution containing 77 wt. % of styrene, 7 wt. % of 1,3-butadiene and 1 wt. % of isoprene continuously for 120 minutes. Polymerization was then performed at 70° C. for 10 minutes by adding a cyclohexane solution containing 5 wt. % of styrene in one minute. Then, 1,3-bis(N,N-glycidylaminomethyl)cyclohexane was added in an amount of 0.3 time the equivalent of n-butyllithium and the resulting mixture was maintained for 10 minutes while stirring. As a stabilizer, 0.3 part by mass, based on 100 parts by mass of the block copolymer, of each of 2-[1-(2-hydroxy-3,5-di-t-pentylphenyl)ethyl]-4,6-di-t-pentylphenyl acrylate and octadecyl-3-(3,5-di-t-butyl-4-hydroxyphenyl)propionate was added, followed by removal of the solvent to yield Block copolymer A-1.

### <Preparation Process of A-2 (C-2)>

In an autoclave equipped with a stirrer, polymerization was performed at 70° C. for 10 minutes by adding all of a cyclohexane solution containing 5 wt. % of styrene, 0.055 part by weight of n-butyllithium, and 0.2 mole, per mole of n-butyllithium, of tetramethylethylenediamine, in one minute in a nitrogen gas atmosphere. Polymerization was then performed at 70° C. by adding a cyclohexane solution containing 80 wt. % of styrene and 10 wt. % of 1,3-butadiene continuously for 120 minutes. Polymerization was then performed at 70° C. for 10 minutes by adding a cyclohexane solution containing 5 wt. % of styrene in one minute. Then, 1,3-bis(N,N-glycidylaminomethyl)cyclohexane was added in an amount of 0.5 time the equivalent of n-butyllithium and the resulting mixture was maintained for 10 minutes while stirring. To the resulting solution of the block copolymer was added 100 ppm, in terms of titanium and based on 100 parts by weight of the block copolymer, of a hydrogenation catalyst and a hydrogenation reaction was performed at a hydrogen pressure of 0.7 MPa and temperature of 65° C. Methanol was then added, followed by the addition of 0.3 part by mass, based on 100 parts by mass of the block copolymer, of octadecyl-3-(3,5-di-t-buty-4-hydroxyphenyl)propionate. The solvent was then removed from the reaction mixture to yield Block copolymer A-2. The hydrogenation ratio of Block copolymer A-2 was controlled to be 97% by a hydrogen amount.

### <Preparation Process of C-3>

In an autoclave equipped with a stirrer, polymerization was performed at 70° C. for 30 minutes by adding all of a cyclohexane solution containing 25 wt. % of styrene, 0.075 part by weight of n-butyllithium, and 0.2 mole, per mole of n-butyllithium, of tetramethylethylenediamine, in one minute. Polymerization was then performed at 70° C. by adding a cyclohexane solution containing 22 wt. % of styrene and 18 wt. % of 1,3-butadiene continuously for 90 minutes. Polymerization was then performed at 70° C. for 30 minutes by adding a cyclohexane solution containing 35 wt. % of styrene in one minute. Then, 1,3-bis(N,N-glycidylaminomethyl)cyclohexane was added in an amount of 0.2 time the equivalent of n-butyllithium and the resulting mixture was maintained for 10 minutes while stirring. Methanol was then added, followed by the addition of, as a stabilizer, 0.3 part by mass, based on 100 parts by mass of the block copolymer, of each of 2-[1-(2-hydroxy-3,5-di-t-pentylphenyl)ethyl]-4,6-di-t-pentylphenyl acrylate and octadecyl-3-(3,5-di-t-butyl-4-hydroxyphenyl)propionate. The solvent was then removed from the reaction mixture to yield Block copolymer C-3.

### <Preparation Process of C-4>

In an autoclave equipped with a stirrer, polymerization was performed at 70° C. for 25 minutes by adding all of a cyclohexane solution containing 20 wt. % of styrene, 0.080 part by weight of n-butyllithium, and 0.2 mole, per mole of n-butyllithium, of tetramethylethylenediamine in one minute in a nitrogen gas atmosphere. Polymerization was then performed at 70° C. by adding a cyclohexane solution containing 20 wt. % of styrene and 25 wt. % of 1,3-butadiene continuously for 100 minutes. Polymerization was then performed at 70° C. for 30 minutes by adding a cyclohexane solution containing 35 wt. % of styrene in one minute. Then, 1,3-bis(N,N-glycidylaminomethyl)cyclohexane was added in an amount of 0.2 time the equivalent of n-butyllithium and the resulting mixture was maintained for 10 minutes while stirring. Methanol was then added, followed by the addition of, as a stabilizer, 0.3 part by mass, based on 100 parts by mass of the block copolymer, of each of 2-[1-(2-hydroxy-3,5-di-t-pentylphenyl)ethyl]-4,6-di-t-pentyphenyl acrylate and octadecyl-3-(3,5-di-t-butyl-4-hydroxyphenyl)propionate. The solvent was then removed from the reaction mixture to yield Block copolymer C-4.

### <Preparation Process of C-9>

In a similar manner to the above-described preparation process of A-1 except that 1,3-bis(N, N-glycidylaminomethyl)cyclohexane was not added, Block copolymer C-9 was obtained.

### (Preparation of an Aliphatic Unsaturated Carboxylate-Styrene Copolymer)

Styrene-n-butyl acrylate copolymers B-1 (equal to D-1) and 8-2 (equal to D-2) were prepared by charging 5 kg of styrene and n-butyl acrylate or methyl methacrylate at a ratio shown in Table 2 and at the same time, charging 0.3 kg of ethylbenzene and a predetermined amount of 1,1-bis(t-butylperoxy)cyclohexane for controlling MFR in a 10-L autoclave equipped with a stirrer, polymerizing the mixture at from 110 to 150° C. for from 2 to 10 hours, and collecting unreacted styrene, n-butyl acrylate and ethylbenzene by a vent extruder. Copolymer B-1 thus obtained had an MFR of 3.0 g/10 min, while Copolymer B-2 thus obtained had an MFR of 2.6 g/10 min.

### Examples 1 to 7 and Comparative Examples 1 and 2

A heat shrinkable film was prepared by an inflation method while using, as a material, Component (I) or a composition of Component (I) and (II) prepared in the above-described process. More specifically, as the material of the invention, the composition containing Components (I) and (II) was used in Examples 1 to 5, while Component (I) was used in Examples 6 and 7.

To 100 parts by weight of Component (I) or the composition were added 0.1 part by weight of erucamide and 0.15 part by weight of 2-(2′-hydroxy-3′-t-butyl-5′-methyl-phenyl)-5-chlorobenzotriazole.

In Comparative Examples 1 and 2, block copolymers having Components (I) with a styrene content of 97 wt. % and 58 wt. %, respectively, and a vinyl aromatic hydrocarbon content of from 65 to 95 wt. % and thus not satisfying the conditions of Component (I) of the present invention were used as materials, respectively.

With regard to the production conditions of a heat shrinkable film, in a first inflation step, a raw sheet having a thickness of 0.11 mm was formed by using a 40-mm extruder and setting a dice temperature at 180° C., a blow-up ratio, from a spider-type annular dice having an aperture of 80 mm, at 1.0 and a draft ratio at 1.15.

In a second inflation step, a 0.05-mm heat shrinkable film was produced by an inflation method by introducing the raw sheet in a hot water of 77° C. and setting a blow-up ratio at 2.1 and draft ratio at 1.1.

A heat shrinkable film producing apparatus (schematic view) employing the inflation method according to the present invention is shown in FIG. 1. The heat shrinkable films thus obtained were used as specimen for the tests of the above-described items from (7) haze to (10) stability in extrusion molding film and the measurement results of these physical properties are shown in Table 3.

The heat shrinkable films (Examples 1 to 7) obtained in the production process of the present invention were each excellent in transparency, rigidity, elongation and shrink properties in both TD and MD. They were also good stability in extrusion molding film and had a uniform film thickness. In Comparative Example 1, on the other hand, a heat shrinkable film was not produced because of breakage during the film formation in the second stage step. In Comparative Example 2, a heat shrinkable film was produced but it lacked stability in extrusion molding film and did not have enough performance as a heat shrinkable film.

### Examples 8 to 12 and Comparative Examples 3 and 4

Heat shrinkable films were produced by an inflation method by using, as a material, Component (III) or a composition composed of Components (III) and (IV) shown in Table 6. More specifically, as the material, the composition composed of Components (III) and (IV) was used in Examples 8 to 11, while Component (III) was used in Example 12.

To 100 parts by weight of Component (III) or the composition were added 0.1 part by weight of erucyl-amide and 0.15 part by weight of 2-(2′-hydroxy-3′-t-butyl-5′-methyl-phenyl)-5-chlorobenzotriazole.

In Comparative Examples 3 and 4, on the other hand, block copolymers having Components (III) with styrene contents of 97 wt. % and 58 wt. %, respectively, and a vinyl aromatic hydrocarbon content of from 65 to 95 wt. % and thus not satisfying the conditions of Component (III) of the present invention were used as materials, respectively.

Production conditions of a heat shrinkable film and production apparatus used therefor were similar to those employed in Examples 1 to 7 and Comparative Examples 1 and 2.

The heat shrinkable films (Examples 8 to 12) obtained in the production process of the present invention were each excellent in transparency, rigidity, elongation and shrink properties in both TD and MD. They showed also good stability in extrusion molding film and had a uniform film thickness.

### Examples 13 to 15 and Comparative Example 5

In accordance with the formulation shown in Table 7, a sheet having a thickness of 0.25 mm was formed at 200° C. by using a 40-mm extruder. Then, at a stretching temperature of 87° C., the sheet was uniaxially stretched by a tenter at a draw ratio of 5 in the transverse direction, whereby a heat shrinkable film having a thickness of about 55 μm was obtained.

In Examples 13 to 15, the composition of Components (II) and (IV) was used. The block copolymer used in Comparative Example 5, on the other hand, contained C-8 and C-9 each free of Component (b) and did not satisfy the requirement for Component (III) of the present invention, that is, a Component (a)/Component (b) ratio falling within a range of from 10/90 to 90/10.

The performances of the resulting heat shrinkable films are shown in Table 7. The heat shrinkable films of the present invention are excellent in rigidity represented by modulus in tension, low temperature shrinkability represented by 80° C. shrinkage, natural shrinkability, −10° C. elongation and transparency represented by Haze.

### INDUSTRIAL APPLICABILITY

The heat shrinkable film formed by the inflation method according to the present invention is transparent and excellent in the balance of physical properties among rigidity, elongation, shrink properties in both TD and MD, and the like and especially it has a uniform film thickness and excellent stability in extrusion molding film. The block copolymer or hydrogenated product thereof, or composition thereof according to the present invention is excellent in tensile properties, optical properties, hardness, stretch properties, molding processability, shrink properties and the like so that it is suited for sheets, films and injection moldings and preferably used for packaging of beverage vessels, various food packaging containers and packaging containers of electronic parts.

### BRIEF DESCRIPTION OF THE DRAWING

FIG. 1 is a schematic view illustrating a heat shrinkable film production apparatus employing the inflation method.

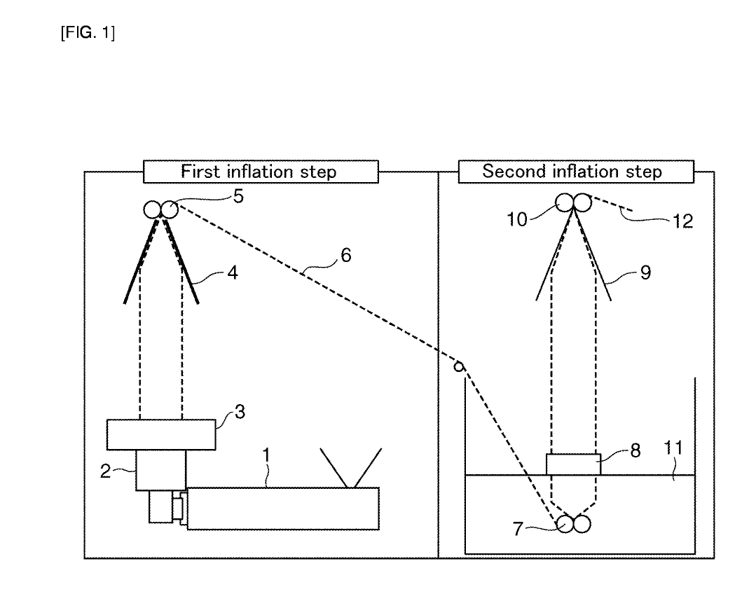

### LEGENDS

1: Extruder, 2: annular die, 3: air-cooled annular-slit system air ring, 4,9: guide plate, 5,7,10: nip roll, 6: raw sheet, 8: cooled, 11: hot water, and 12: stretched film.

1-8. (canceled)

9. A heat shrinkable film
produced by a first inflation step of forming, at a temperature of from 150 to 250° C., a raw sheet tube having a thickness of from 0.05 to 0.5 mm by using a material which contains a block copolymer having a vinyl aromatic hydrocarbon content of from 65 to 95 wt. % and a conjugated diene content of from 5 to 35 wt. % or hydrogenated product thereof (I) and has a storage elastic modulus (E′), at 50° C., of from 0.7×10⁹ to 2.5×10⁹ Pa; and
a second inflation step, successively to the first inflation step, of stretching the tube to from 1.5 to 5 times the original length in the transverse direction (TD) in a fluid having a viscosity of film, wherein a ratio of the diameter of the raw sheet tube to the diameter of the tube of heat shrinkable film is from 1.5 to 5;
the film having a shrinkage ratio, as measured at 90° C. for 5 seconds, not greater than 20% in the machine direction (MD) and from 20 to 60% in the transverse direction (TD).

10. A block copolymer having a vinyl aromatic hydrocarbon content of from 65 to 95 wt. % and a conjugated diene content of from 5 to 35 wt. %, or hydrogenated product thereof (III) having a storage rigidity modulus (E′) at 30° C. of 3×10⁸ Pa or greater, having at least one peak temperature of a loss elastic modulus (E″) within a range of 60° C. or greater but not greater than 110° C., which comprises Component (a) having at least one peak molecular weight, as measured by gel permeation chromatography (GPC), within a range of from 3000 to 300000 and Component (b) polymerized by a trifunctional or higher multifunctional coupling agent and having at least one peak molecular weight within a range exceeding 30000 but not greater than 1000000 at a Component (a)/Component (b) weight ratio of from 10/90 to 90/10.

11. A block copolymer or hydrogenated product thereof (III) according to claim 10, wherein Component (a) has at least one peak molecular weight within a range of from 50000 to 250000.

12. A block copolymer or hydrogenated product thereof (III) according to claim 10, wherein Component (b) has at least one peak molecular weight within a range exceeding 350000 but not greater than 900000.

13. A block copolymer or hydrogenated product thereof (III) according to claim 10, wherein the storage elastic modulus (E′) at 30° C. is 5×10⁸ Pa or greater and the loss elastic modulus (E′) has at least one peak temperature within a range of 65° C. or greater but not greater than 105° C.

14. A composition comprising a block copolymer or hydrogenated product thereof (III) as claimed in claim 10 and at least one of the following polymers (α) to (ε) as polymer (IV):
(α) a block copolymer composed of a vinyl aromatic hydrocarbon and a conjugated diene or hydrogenated product thereof which does not contain the block copolymer or hydrogenated product thereof (III),
(β) a vinyl aromatic hydrocarbon polymer,
(γ) a copolymer composed of a vinyl aromatic hydrocarbon and an aliphatic unsaturated carboxylic acid derivative, and
(ε) a rubber-modified styrene polymer,
at a (III)/(IV) weight ratio of from 1/99 to 99/1.

15. A composition according to claim 14, wherein a (E′40/E′20) ratio, that is a ratio of a storage elastic modulus at 40° C. (E′40) to a storage elastic modulus at 20° C. (E′20) is from 0.75 to 1, at least one peak temperature of a function tan δ in measurement of a dynamic viscoelasticity is present within a range of from 70 to 125° C., and a weight ratio of the block copolymer or hydrogenated product thereof (III) to the polymer (IV) is from 5/95 to 95/5.

16. A composition according to claim 14, which further comprises from 0.01 to 5 parts by weight, based on 100 parts by weight of the block copolymer or hydrogenated product thereof (III) and the polymer (IV), of at least one lubricant selected from fatty acid amides, paraffins, hydrocarbon resins and fatty acids.

17. A composition according to claim 14, which further comprises from 0.05 to 3 parts by weight, based on 100 parts by weight of the block copolymer or hydrogenated product thereof (III) and the polymer (IV), of at least one stabilizer selected from 2-[1-(2-hydroxy-3,5-di-t-pentylphenyl)ethyl]-4,6-di-t-pentylphenyl acrylate, 2-t-butyl-6-(3-t-butyl-2-hydroxy-5-methylbenzyl)-4-methylphenyl acrylate and 2,4-bis[(octylthio)methyl]-o-cresol.

18. A composition according to claim 14, which further comprises from 0.05 to 3 parts by weight, based on 100 parts by weight of the block copolymer or hydrogenated product thereof (III) and the polymer (IV), of at least one ultraviolet absorber or light stabilizer selected from benzophenone ultraviolet absorbers, benzotriazole ultraviolet absorbers and hindered amine light stabilizers.

19. A sheet film comprising the block copolymer or hydrogenated product thereof (III) as claimed in claim 10.

20. A heat shrinkable film comprising the block copolymer or hydrogenated product thereof (III) as claimed in claim 10.

21. A heat shrinkable film obtained by a production process comprising a first inflation step of forming a tube having a thickness of from 0.05 to 0.5 mm at a draft ratio of from 1 to 15 by using the block copolymer or hydrogenated product thereof (III) as claimed in claim 10; and a second inflation step, successively to the first inflation step, of stretching the tube to from 1.5 to 5 times the original length in the TD in a fluid of from 65 to 100° C.

22. A sheet film comprising the composition as claimed in of claim 14.

23. A heat shrinkable film comprising the composition as claimed in claim 14.

24. A heat shrinkable film obtained by a production process comprising a first inflation step of forming a tube having a thickness of from 0.05 to 0.5 mm at a draft ratio of from 1 to 15 by using a composition as claimed in claim 14 and a second inflation step, successively to the first inflation step, of stretching the tube to 1.5 to 5 times the original length in the TD in a fluid of from 65 to 100° C.
